(19) United States
(12) Patent Application Publication
(10) Pub. No.: US 2003/0135411 A1
(43) Pub. Date: Jul. 17, 2003

(54) Content adaptation service control system

(76) Inventors: Kazumasa Ushiki, Kawasaki (JP); Takeshi Yasuie, Kawasaki (JP); Hiroyuki Taniguchi, Kawasaki (JP); Mitsuhiro Nakamura, Kawasaki (JP); Chammika Subasinghe, Kawasaki (JP); Takeshi Sumiya, Tokyo (JP)

Correspondence Address: KATTEN MUCHIN ZAVIS ROSENMAN, 575 MADISON AVENUE, NEW YORK, NY, 10022-2585, US

(21) Appl. No.: 10/191,980

(22) Filed: Jul. 9, 2002

(30) Foreign Application Priority Data
Jan. 11, 2002 (JP) 2002-005088

(51) Int. Cl. G06F 17/60

(52) U.S. Cl. 705/14; 709/246

(57) ABSTRACT

A content adaptation service control system includes a content adaptation server device for carrying out a predetermined content adaptation service for original content data retained in a content server device in response to a content data acquisition request given from a client device utilized by a user, an edge device, in a network, judging a necessity for, when receiving the content data acquisition request from the client device, starting the content adaptation service and notifying of a startup request, and a service control device determining, when notified of the startup request from the edge device, a mode of the content adaptation service that should be carried out by the content adaptation server device on the basis of contract information about the user subscribing the content adaptation service, and transmitting the determined mode of the content adaptation service as a processing request to the edge device.

### BACKGROUND OF THE INVENTION

The present invention relates generally to a content adaptation service control system, and more particularly to a content adaptation service control system capable of easily providing a variety of eager-to-subscribe network services.

Under a background where an IP (Internet Protocol) network such as the Internet has spread, there is shown a tendency of a rapid increase in utilizing data communication services such as E-mails and Web accessing as network services.

A content adaptation service related to Web contents, which is categorized as the data communication service, is a service for giving a value added to the Web accessing, wherein an examination of a content adaptation protocol ICAP (Internet Content Adaptation Protocol) is underway in IETF (Internet Engineering Task Force) (refer to [http://www.ietf.org/internet-drafts/draft-elson-opes-icap-01.txt]).

The content adaptation service is exemplified by access filtering to a Web server on the basis of URL (Uniform Resource Locator), an insertion (addition) of an advertisement suited to a favorite of a user, a virus check and a language translation of a Web page.

In a network system for providing such a content adaptation service, a content adaptation server function for executing the content adaptation processing is installed mainly within a proxy cache device defined as a proxy server having a cache function or within a device existing on a route leading to a content server device.

When utilizing the content adaptation protocol ICAP, an ICAP server function corresponding to the content adaptation server function can be installed in a device other than the devices described above.

The content adaptation protocol ICAP, however, merely defines a scheme for interworking the ICAP server and the ICAP client with each other. Further, the content adaptation protocol ICAP does not presume an architecture for dynamically controlling the proxy cache device and the content adaptation server device having the content adaptation server function from an external control device.

The prior art network system for providing the content adaptation services described above has the following problems:

(1) The installing location of the content adaptation server device is fixed, and hence the content adaptation server device is required to correspond all types of content adaptation modes, with the result that the variety of content adaptation server functions can not be flexibly disposed in the network. This problem can be, however, obviated by utilizing the protocol ICAP.

(2) The installing destination of the content adaptation server function is fixedly determined, and therefore load sharing of the content adaptation server function is hard to carry out. This problem can be, however, obviated by utilizing the protocol ICAP.

(3) The post-processing content corresponding to a result of the content adaptation processing executed in a certain content adaptation server device can not be reused in the content adaptation server device, and hence the content adaptation server device can not be effectively utilized as a resource.

(4) Moreover, existences of a content adaptation processing entrepreneur specialized in the content adaptation processing and of a content adaptation service provider who flexibly provides a subscriber with the content adaptation service on the basis of a favorite of a subscriber (who is an end user utilizing a client device), are not yet realized so far. In the case of providing the flexible content adaptation service based on the favorite of the subscriber by utilizing the protocol ICAP, the content adaptation service vendor retaining the information on the subscriber's favorite possesses a device having an ICAP client function or an ICAP server function and is required to dispose this device in the IP network. The content adaptation service vendor is therefore difficult to participate in this service business.

### SUMMARY OF THE INVENTION

It is a primary object of the present invention, which was devised to obviate those problems, to provide a technique capable of easily providing a variety of eager-to-subscribe network services.

To accomplish the above object, a first content adaptation service control system according to the present invention is provided with a content adaptation server device for carrying out a predetermined content adaptation service for original content data retained in a content server device in response to a content data acquisition request given from a client device utilized by a user, and comprises an edge device, in a network, judging a necessity for, when receiving the content data acquisition request from the client device, starting the content adaptation service and notifying of a startup request, and a service control device determining, when notified of the startup request from the edge device, a mode of the content adaptation service that should be carried out by the content adaptation server device on the basis of contract information about the user subscribing the content adaptation service, and transmitting the determined mode of the content adaptation service as a processing request to the edge device.

In a second content adaptation service control system according to the present invention, the service control device determines the mode of the content adaptation service applied to the content data acquisition request transmitted from the client device, and makes a request for transferring the determined mode of the content adaptation service and the content data acquisition request to the content adaptation server device, and the edge device transfers the determined mode of the content adaptation service and the content data acquisition request to the content adaptation service device in response to the request given from the service control device, receives from the content adaptation server device a post-processing content on which the content adaptation service is effected, then transfers this post-processing content to the content server device and acquires the original content data.

In a third content adaptation service control system according to the present invention, the service control device determines the mode of the content adaptation service applied to the original content data transmitted from the content server device, and makes a request for transferring the determined mode of the content adaptation service and the original content data transmitted from the content server device to the content adaptation server device, and the edge device transfers the determined mode of the content adaptation service and the original content data to the content adaptation service device in response to the request given from the service control device, receives from the content adaptation server device a post-processing content on which the content adaptation service is effected, and transfers this post-processing content to the client device.

In a fourth content adaptation service control system according to the present invention, the content adaptation service includes access filtering to the content server device on the basis of URL, an insertion of an advertisement suited to a favorite of the user, a virus check and a language translation.

In a fifth content adaptation service control system according to the present invention, the service control device includes a first storage module retaining an identifier of the client device utilized by the user and content adaptation service category information as the contract information about the user subscribing the content adaptation service.

In a sixth content adaptation service control system according to the present invention, the service control device further includes a second storage module retaining attribute information of a pre-processing content corresponding to the original content data, a mode of the content adaptation service applied to the pre-processing content, attribute information of a post-processing content on which the content adaptation service is effected, and an identifier of an edge device in which the post-processing content is stored as a cache.

In a seventh content adaptation service control system according to the present invention, the service control device further includes a third storage module retaining an identifier of the client device that provided with the content adaptation service, content adaptation service category information, and service providing time information as accounting information about the content adaptation service.

In an eighth content adaptation service control system according to the present invention, the edge device includes a content transfer module transmitting and receiving the content to and from at least one of the client device, the content server device, the content adaptation server device and other edge device, an interworking module interworking with at least one of the service control device and the content adaptation server device, a first cache module retaining as a cache the pre-processing content corresponding to the original content data, a second cache module retaining as a cache the post-processing content corresponding to a result of the content adaptation service effected in the content adaptation server device on the basis of the original content data, and a proxy module judging the necessity for starting the content adaptation service and cooperating with the first cache module, the second cache module and the interworking module.

In a ninth content adaptation service control system according to the present invention, the edge device further includes a client module requesting the other edge device to acquire the post-processing content cached in the second cache module, and a server module transmitting, as a response, the post-processing content cached in the second cache module in a self edge device in response to a request from a client module in the other edge device.

In a tenth content adaptation service control system according to the present invention, the service control device determines a mode of the content adaptation service that should be applied to the pre-processing content requested by the client device, thereafter searches the second storage module wherein the attribute information of the pre-processing content requested by the client device and the mode of the content adaptation service applied to the pre-processing content, are used as key information, detects that a cache corresponding to the post-processing content concerned exists is retained in the edge device as a present control target, commands in this case the edge device to use a cache corresponding to the post-processing content without carrying out the content adaptation service in the content adaptation server device, and transmits the post-processing content to the client device from the edge device.

In an eleventh content adaptation service control system according to the present invention, the service control device determines a mode of the content adaptation service that should be applied to the pre-processing content requested by the client device, thereafter searches the second storage module wherein the attribute information of the pre-processing content requested by the client device and the mode of the content adaptation service applied to the pre-processing content, are used as key information, detects that a cache corresponding to the post-processing content concerned exists is retained in other edge device that is not set as a present control target, commands in this case the present control target edge device to acquire a cache corresponding to the post-processing content from the other edge device retaining the cache corresponding to the post-processing content without carrying out the content adaptation service in the content adaptation server device, and transfers the post-processing content acquired by the edge device to the client device.

In a twelfth content adaptation service control system according to the present invention, the service control device, when the post-processing content is generated in the content adaptation server device or when acquiring the post-processing content from the other edge device, selects as to whether the post-processing content is cached in the cache module of the present control target edge device, and, on the occasion of caching it, registers respective pieces of information about the post-processing content in the second storage module.

In a thirteenth content adaptation service control system according to the present invention, the service control device, when detecting that the pre-processing content retained in the content server device has been update, requests the edge device retaining as the cache the post-processing content generated based on the pre-processing content or the server module of in the other edge device to delete the post-processing content from the cache module, and deletes the respective pieces of information about the delete target post-processing content from the second storage module.

In a fourteenth content adaptation service control system according to the present invention, the service control device, when detecting that the pre-processing content retained in the content server device is updated, makes the client module in the edge device or the other edge device generate an acquisition request of the updated pre-processing content, performs control of applying the content adaptation service to the pre-processing content, and the client module of the edge device or the other edge device, when acquiring from the content adaptation server device the post-processing content to which the content adaptation service is applied, registers this post-processing content in the cache module.

According to the present invention, the following effects can be expected.

(1) The content adaptation function can be installed in a device, e.g., a dedicated content adaptation service device other than the edge device (a proxy cache device).

(2) A service control device for controlling the edge device and the content adaptation server device in a network from outside, is newly defined, and a transfer of the content to the content adaptation server device from the edge device and the control of the content server adaptation server device with a content adaptation service mode specified, can be controlled by the service control device.

(3) A certain edge can acquire a desired post-processing content from other edge device by checking which edge device manages the already-processed content.

(4) An architecture can be separated into the edge device having basic networking functions and the content adaptation server device having a function peculiar to the content adaptation processing, and interfaces between the respective functions are defined, whereby the service control device is set capable of flexibly corresponding to an addition of a new service. With this scheme, the content adaptation service provider having the information about the favorites of the subscribers can easily participate in the content adaptation service business without having the edge device for providing the basic networking functions and the content adaptation function such as a language translation function etc. Moreover, a content adaptation processing entrepreneur having only the content adaptation processing function such as a language translation and so on, becomes easy to participate in the content adaptation business on the premise that the content adaptation service provider described above exists.

### BRIEF DESCRIPTION OF THE DRAWINGS

The foregoing and other features and advantages of the present invention will become more readily appreciated as the same becomes better understood by reference to the following detailed description when taken into conjunction with the accompanying drawings wherein:

FIG. 1 is a block diagram showing an architecture of a content adaptation service control system in one embodiment of the present invention;

FIG. 2 is a block diagram showing detailed configurations of a service control device and an edge device in FIGS. 1;

FIG. 3 is a diagram showing an example of a structure of a subscriber management database;

FIG. 4 is a diagram showing an example of a structure of a cache management database;

FIG. 5 is a diagram showing an example of a structure of an accounting database;

FIG. 6 is a flowchart showing processing steps of a client device;

FIG. 7 is a flowchart showing processing steps of a content server device;

FIG. 8 is a flowchart showing processing steps of a content transfer module of the edge device;

FIG. 9 is a flowchart showing processing steps of a proxy module of the edge device;

FIG. 10 is a flowchart showing processing steps of a proxy module of the edge device;

FIG. 11 is a flowchart showing processing steps of an interworking module of the edge device;

FIG. 12 is a flowchart showing processing steps of the interworking module of the edge device;

FIG. 13 is a flowchart showing processing steps of a service control module of a service control device;

FIG. 14 is a flowchart showing processing steps of the service control module of the service control device;

FIG. 15 is a flowchart showing processing steps of the service control module of the service control device;

FIG. 16 is a flowchart showing processing steps of the service control module of the service control device;

FIG. 17 is a flowchart showing processing steps of the service control module of the service control device;

FIG. 18 is a flowchart showing processing steps of a post-processing content client module of the edge device;

FIG. 19 is a flowchart showing processing steps of a post-processing content server module of the edge device;

FIG. 20 is a flowchart showing processing steps of a content adaptation server device;

FIG. 21 is an explanatory sequence chart showing content adaptation processing to a content request;

FIG. 22 is an explanatory sequence chart showing the content adaptation processing to a content response;

FIG. 23 is an explanatory sequence chart showing the content adaptation processing to the content response;

FIG. 24 is an explanatory sequence chart showing the content adaptation processing to the content response;

FIG. 25 is an explanatory sequence chart showing a transfer of the post-processing content between the edge devices;

FIG. 26 is an explanatory sequence chart showing a deletion of the post-processing content in the edge device; and

FIG. 27 is an explanatory sequence chart showing a generation of a network-led post-processing content.

### DETAILED DESCRIPTION OF THE PREFERRED EMBODIMENTS

Next, an embodiment of the present invention will hereinafter be discussed with reference to the accompanying drawings.

[Architecture and Functions of Content Adaptation Service Control System]

<Content Adaptation Service Control System>

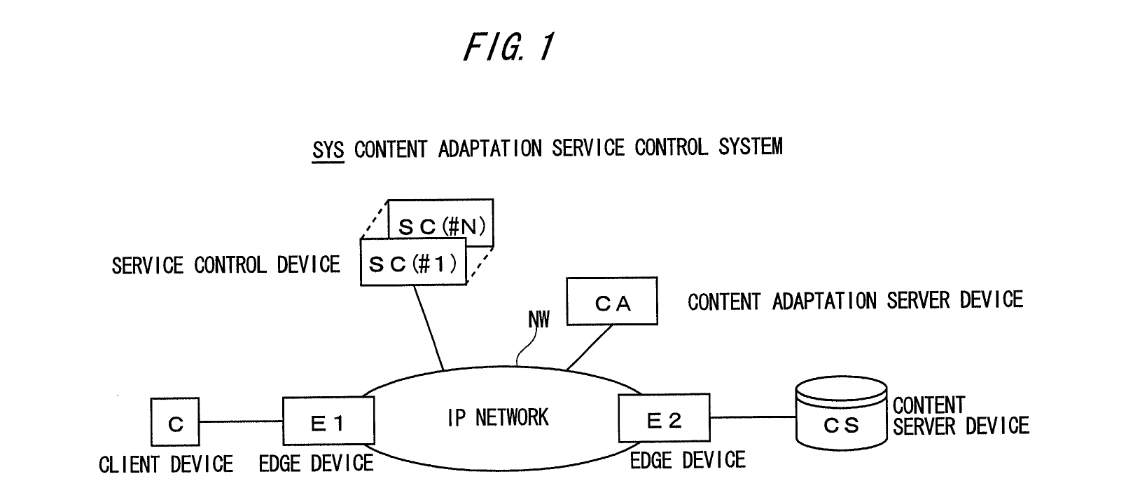

FIG. 1 shows a system architecture in one embodiment of the present invention. Referring to FIG. 1, this content adaptation service control system SYS includes an IP network NW such as the Internet or Intranet accommodating edge devices (proxy cache devices) E1, E2 serving as edge nodes located ingress and egress edge positions of the communication network (IP network), a content server device CS such as a provider server, accommodated via the edge device E2 in the IP network NW, for retaining an original of content (original content data), and a client device C, accommodated via the edge device E1 in the IP network NW, such as a personal computer utilized by an end user who requests the content server device CS to obtain the content.

The client device C may be, on condition that a communication function, an information display function and a information specifying function are provided therein, a single or composite unit of a fixed telephone terminal categorized as L-mode etc, a mobile phone terminal categorized as i-mode, EZweb, J-sky etc, and a mobile information terminal such as PDA (Personal Digital Assistant), a notebook-size personal computer and so on.

The content adaptation service control system SYS further includes a content adaptation server device CA for executing a predetermined content processing for a content, and a plurality of service control devices SC (#1 through #N) that actualize the content adaptation service by controlling the edge device E1 and the content adaptation service device CA on the basis of content adaptation service control application (application program) APL.

As a technique by which the content adaptation service control application APL controls the edge device E1 and the content adaptation service CA, there can be utilized open network control APIs (Application Programming Interfaces) based on a concept defined as in JAIN (Java APIs for Integrated Network) (JAIN is a set of Java technology-based APIs) (refer to [http://java.sun.com/products/jain/index.html]) and Parlay Group (which jointly works with JAIN) (refer to [http://www.parlay.org]).

More precisely, the IP network NW accommodates the content adaptation server device CA and the service control devices SC via the edge devices, however, illustrations of these edge devices are omitted herein. Each of the content adaptation server device CA, the content server device CS and the client device C is, though a plurality of devices in every device category are actually provided, illustrated herein by way of one representative device.

In this content adaptation service control system SYS, the edge device E1 interworks with the service control device SC when executing the content adaptation processing. The edge device E1 has a function of judging a necessity (trigger) for starting the content adaptation service and notifying the service control device SC of this necessity, and a function of receiving and executing a control command issued from the service control device SC.

The service control device SC has a function of retaining subscription contract information on an end user (who might be called a user or a subscriber) entering into a contract of the content adaptation service, and determining, based on this piece of subscription information, a content adaptation service mode (content adaptation rule) that should be executed. The content adaptation server device CA has a function of executing the content adaptation processing in accordance with the content adaptation service mode determined by the service control device SC.

The content adaptation service is exemplified by. E.g., an access filter to a Web server (the content service device CS) on the basis of a URL, an insertion (addition) of an advertisement suited to a favorite of the end user, a virus check, and a language translation such as an English-Japanese conversion etc of a Web page and so on.

<Service Control Device and Edge Device (E1)>

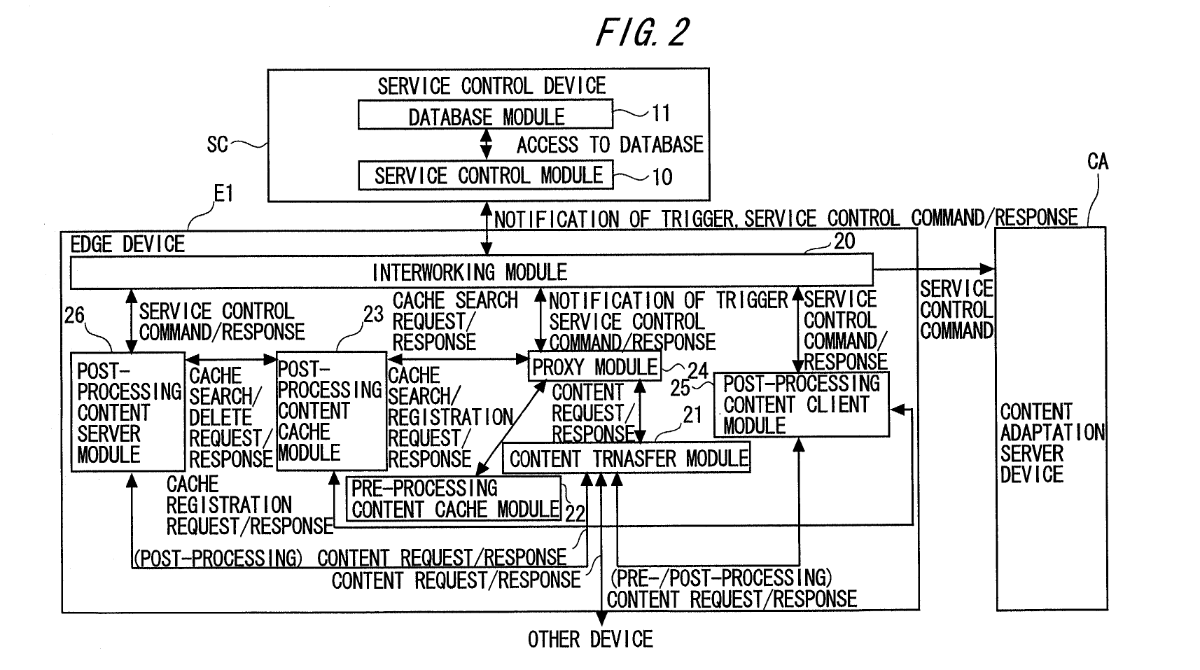

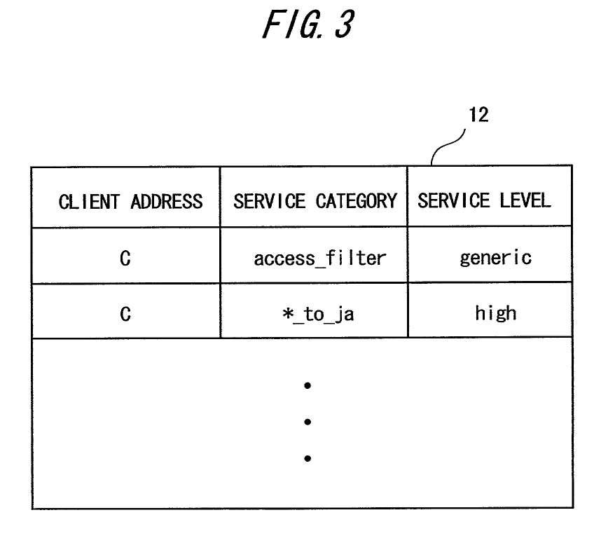

FIG. 2 shows details of architectures of the service control device SC and the edge device E1 in the content adaptation service control system SYS. FIGS. 3, 4 and 5 show detailed structures of a database module of the service control device SC.

Referring to FIGS. 1 through 5 in combination, the service control device SC is constructed of a service control module 10 and a database module 11. The database module 11 includes a subscriber management database 12, a cache management database 13 and an accounting database 14.

In this database module 11, the subscriber management database 12 retains, as pieces of contract information on the user as a subscriber of the content adaptation service, an identifier of the client device C utilized by the user, a service category information of the content adaptation service and service level information. The cache management database 13 manages attribute information of a post-processing content and as to which edge device retains the post-processing content. Further, the accounting database 14 manages accounting information about the content adaptation processing.

The edge device E1 is constructed of an interworking module 20 that interworks with the service control device SC and the content adaptation service device CA, a content transfer module 21 for transferring and receiving the content to and from other devices, a pre-processing content cache module 22 for retaining the original of content as a cache (which is defined as a cached content in the following discussion), a post-processing content cache module 23 for retaining, as a cache, a result of the content adaptation processing conducted in the content adaptation service device CA on the basis of the original of content, and a proxy module 24 that analyzes a startup trigger of the content adaptation service and cooperates with the two cache modules 22, 23 and the interworking module 20.

The edge device E1 further includes a post-processing content client module 25 for requesting other edge device to obtain the post-processing content cached in the post-processing content cache module 23 in the same other edge device, and a post-processing content cache module 26 that responds to a request given from the post-processing content client module 25 in other edge device about the post-processing content cached in the post-processing content cache module 23 in the self-edge device.

The service control device SC determines the content adaptation rule that should be applied to the content (pre-processing content) transferred from the client device C when implementing the content adaptation service, notifies the content adaptation server device CA among the plural devices CA of the content adaptation rule, and requests the edge device E1 to transfer to the content adaptation server device CA the content transferred from the client device C.

In response to a request given from the service control device SC, the edge device E1 receives, after transferring to the content adaptation server device CA the pre-processing content transmitted from the client device C, the content (the post-processing content) having undergone the processing from the content adaptation server device CA, and transfers this post-processing content to the content server device CS.

Further, the service control device SC determines the content adaptation rule that should be applied to the content transferred from the content server device CS when implementing the content adaptation service, notifies the target content adaptation server device CA of the content adaptation rule, and requests the edge device E1 to transfer to the content adaptation server device CA the content transferred from the content server device CS.

In response to a request given from the service control device SC, the edge device E1 receives, after transferring to the content adaptation server device CA the content transmitted from the content server device CS, the post-processing content from the content adaptation server device CA, and transfers this post-processing content to the client device C.

To be describe it in greater detail, the service control module 10 in the service control device SC, after determining the content adaptation rule that should be applied to the pre-processing content requested from the client device C, searches the cache management database 13 of the database module 11, wherein the identifier of the pre-processing content requested from the client device C and the content adaptation rule that should be applied to this pre-processing content are used as key information.

The service control module 10, if it proves as a result of the search that the post-processing content cache is retained in the present control target edge device E1, commands this edge device E1 to utilize the same post-processing content cache without executing the content adaptation processing in the content adaptation server device CA.

Then, the edge device E1 transmits the specified post-processing content cache to the client device C.

Further, the service control module 10, after determining the content adaptation rule that should be applied to the pre-processing content requested from the client device C, searches the cache management database 13 of the database module 11, wherein the identifier of the pre-processing content requested from the client device C and the content adaptation rule that should be applied to this pre-processing content are used as key information.

The service control module 10, if it proves as a result of the search that the post-processing content cache is retained in an edge device other than the present control target edge device, commands the present control target edge device E1 to obtain the post-processing content cache from the post-processing content server module 26 in other edge device retaining this cache without executing the content adaptation processing in the content adaptation server device CA.

Then, the control target edge device E1 transfers the obtained post-processing content to the client device C.

Moreover, the service control module 10, when the post-processing content is generated in the content adaptation service device CA and when the post-processing content is obtained from other edge device, selects as to whether this post-processing content is cached in the post-processing content cache module 23 in the control target edge device E1. This selection can be made based on, with utilization ratios of the content server device CS and of the pre-processing content being measured, judging whether each of these measured values exceeds a certain fixed value. The service control module 10, when selecting caching, registers the information on this post-processing content in the cache management database 13.

Further, the service control module 10, when detecting that the pre-processing content retained in the content server device CS has been updated, requests the post-processing content server module 26, in the edge device retaining, as a cache, the post-processing content generated based on the content before being updated, to delete this content.

Then, the post-processing content server module 26 in this edge device deletes this post-processing content from the post-processing content cache module 23, and simultaneously deletes registration information about the delete target content from the cache management database 13.

Moreover, the service control module 10, when detecting that the pre-processing content retained in the content server device CS has been updated, generates a content acquisition request of requesting the post-processing content client module 25 in a certain edge device to acquire the updated content, and executes controlling so that the predetermined content adaptation rule is applied to the content.

With this operation, the post-processing content client module 25 in the edge device, when obtaining the post-processing content to which the content adaptation rule is applied, registers this post-processing content in the post-processing content cache module 23.

<Subscriber management Database 12 of Service Control Device SC>

As shown in FIG. 3, the subscriber management database 12 in the service control device SC retains pieces of information such as an address (client address) of the client device C, a service category of which the subscriber enters into the contract, and a service level (if defined) of each service.

The database 12 in this example shows that a subscriber having a client address [C] subscribes two categories of services. The first service is categorized into an access filter service (recognized by the service category [access_filter]), of which a service level is a generic service (recognized by the service level [generic]). The second service is categorized into a translation service (recognized by the service category [*_to ja]) for translating a foreign language such as English etc into Japanese, of which the service level is that this translation service utilizes a high-level dictionary. Note that other pieces of information may also be stored in the subscriber management database 12 as the necessity arises.

Herein, the client address will be explained in detail. The client address is defined as an identifier allocated to an individual user when subscribing the service, whereby the user can be uniquely identified based on this client address.

The client address basically remains unchanged till the service contract expires. Under such a condition that the client address attaching information such as the service contract information and all pieces of information managed based on the client address are updated based on anew client address, however, the client address can be changed. The service control device SC manages the individual user on the basis of this client address.

Herein, when the user accesses the IP network NW (more precisely the edge device E1) by use of, e.g., the client device C as a Web client, an address (e.g., an IP address) having a different system from the client address is dynamically given to the client device C from the IP network NW. In this case, the client device C notifies the edge device E1 a client address (which is, for example, inputted from the user when accessing the IP network NW or is set beforehand in the client device C), and obtains an IP address as a response thereto.

The edge device E1, when the first network access request occurs from the user, allocates an IP address related to the client address of which the client device C has notified, and registers a mapping relationship between these two types of addresses in an address mapping table (not shown). Further, the edge device E1 retains also a mapping relationship between the startup trigger of the content adaptation service and the IP address.

The client device C, when sending the content acquisition request message (which is, for instance, an HTTP (HyperText Transfer Protocol) request message transferred via a TCP (Transmission Control Protocol) connection established), sets the obtained IP address as a source address in the request message and thus sends this message.

The edge device E1 judges the startup trigger of the content adaptation service on the basis of the IP address set in the content acquisition request message sent from the client device C or a content acquisition response message (which is, for example, an HTTP response message transferred via the TCP connection established) sent from the content server device CS as a response to the content acquisition request message.

The IP address allocated to the client terminal C is set as a source address in the content acquisition request message or as a destination address in the content acquisition response message.

Note that when the edge device E1 sets the TCP connection to the content server device CS, there may be used the IP address and a port number given by the edge device E1 to the client device C. In this case, the IP address coupled with the port number, which are given by the edge device E1 to the client terminal C, is set as the source address in the content acquisition request message or as the destination address in the content acquisition response message.

The edge device E1 retains the mutual address relationship between the IP address of the client device C and the IP address coupled with the port number given mapping thereto in the form of the IP address mapping table (not shown), thereby judging the trigger with respect to the client device C.

This scheme is based on an assumption of such a case that two different TCP connections are established between the client device C and the edge device E1 and between the edge device E1 and the content server device CS, and when the edge device E1 establishes the TCP connection between the edge device E1 and the content server device CS, the IP address coupled with the port number possessed by the edge device E1 itself (permitted to use this IP address coupled with the port number) is used as the source address.

The edge device E1, when detecting the startup trigger of the content adaptation service with respect to a certain IP address, searches for a client address mapping to the IP address by referring to the IP address mapping table. Thereafter, the edge device E1 notifies the service control device SC of the detection of the trigger and so on by use of the client address.

The scheme described above is applied to a case where the user is identified based on only the client address between the edge device E1 and the service control device SC without letting the service control device SC is aware of the IP address. Namely, this is the scheme in which the service control device SC may simply know just the client address.

Note that there can be also applied a scheme in which the service control device SC is notified of the mapping relationship between the allocated IP address and the client address when allocating the IP address to the client device C, and the user identified based on only the IP address on occasion of performing the subsequent communications between the edge device E1 and the service control device SC, and a scheme using the two address systems in combination.

Further, in the discussion made so far, the edge device E1 has the function of allocating the IP address (an IP address allocating function), however, if the edge device E1 is capable of generating the client address and the address mapping table showing the mapping between this client address and the IP address given mapping thereto, the IP address allocating function may be provided in a specially-located device (which is, e.g., an IP address allocation server device) other than the edge device E1.

Note that if a certain user always utilizes the client device C for exclusive use of this user and if this client device C is not moved to other places, a fixed IP address is allocated when subscribing the network access service, and this fixedly allocated IP address may be used directly as the client address. According to IPv4, it is contemplated impossible to put such a premise due to a restriction in terms of an IP address space, however, this premise is possible in the Intranet wherein private addresses can be freely used.

This scheme enables the IP network NW (more precisely the edge device E1) to eliminate the necessity of the function of dynamically allocating the IP address each time the user accesses the IP network NW and the function of managing the address mapping table.

<Cache Management Database 13 of Service Control Device SC>

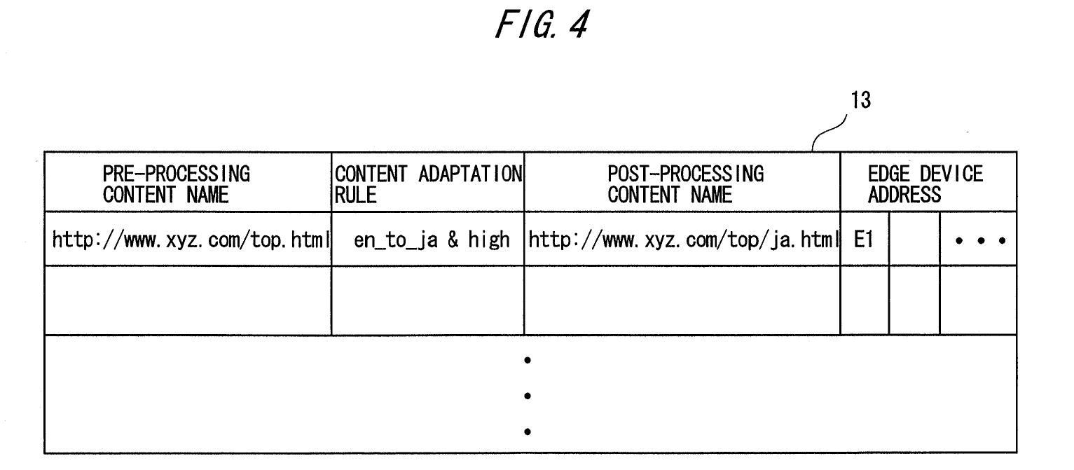

As shown in FIG. 4, the cache management database 13 in the service control device SC retains pieces of information such as a pre-processing content name (a name of the original of the content retained in the content server device CS), a content adaptation rule applied t the pre-processing content, a post-processing content name, an address of the edge device retaining the post-processing content as a cache.

The database 13 in this example shows that an English-to-Japanese translation service (identified by the content adaptation rule such as [en_to_ja & high]) using the high-level dictionary is applied to a pre-processing content [http://www.xyz.com/top.html], a post-processing content [http://www.xyz.com/top/ja.html] is thereby generated, and this post-processing content is cached in the edge device E1 having an address [E1]. Note that pieces of information such as a period of validity and an update date/time of the pre-processing content in addition to these pieces of information are stored in the cache management database 13, thereby making it possible to detect that the pre- and post-processing contents become old.

Further, in a case where there exist a plurality of content adaptation service providers having the service control devices SC, there might arise such a case that the post-processing content, though the pre-processing content is the same, becomes different if the content adaptation service provider is different. Therefore, pieces of name information of the content adaptation service providers may be retained in addition to those pieces of information, or the cache management database 13 may be managed in segmentation for every content adaptation service provider. Moreover, other pieces of information may be stored in the cache management database 13 according to the necessity.

<Accounting Database 14 of Service Control Device SC>

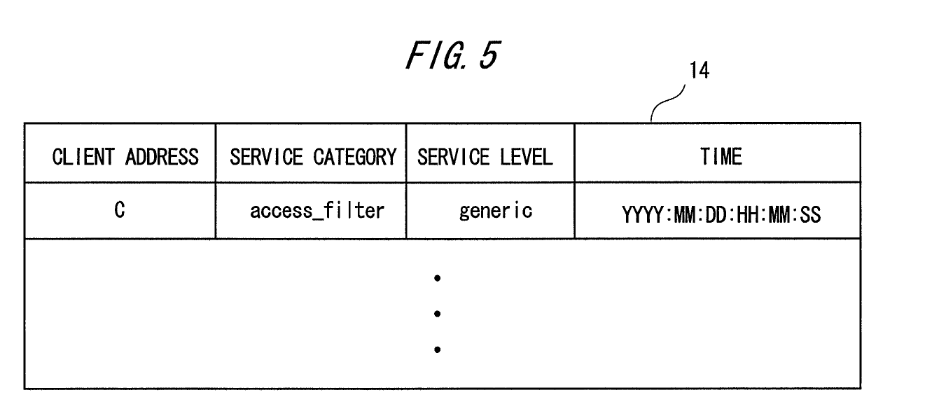

As shown in FIG. 5, the accounting database 14 in the service control device SC retains pieces information such as an address of the client device C receiving the content adaptation service, a name of the content adaptation service category provided to the client device C, a content adaptation service level and a service providing time.

The database 14 in this example shows that the user having a client address [C] is provided with a service coming under a service category [access_filter] (access filer service) having a service level [generic] (general) at a certain time [YYYY:MM:DD:HH:MM:SS] (year/month/date/hour/minute/second). Note that the accounting database 14 may be managed in segmentation for every content adaptation service provider. Further, other pieces of information may also be stored in the accounting database 14 as the necessity arises.

[Operations of Content Adaptation Service Control System]

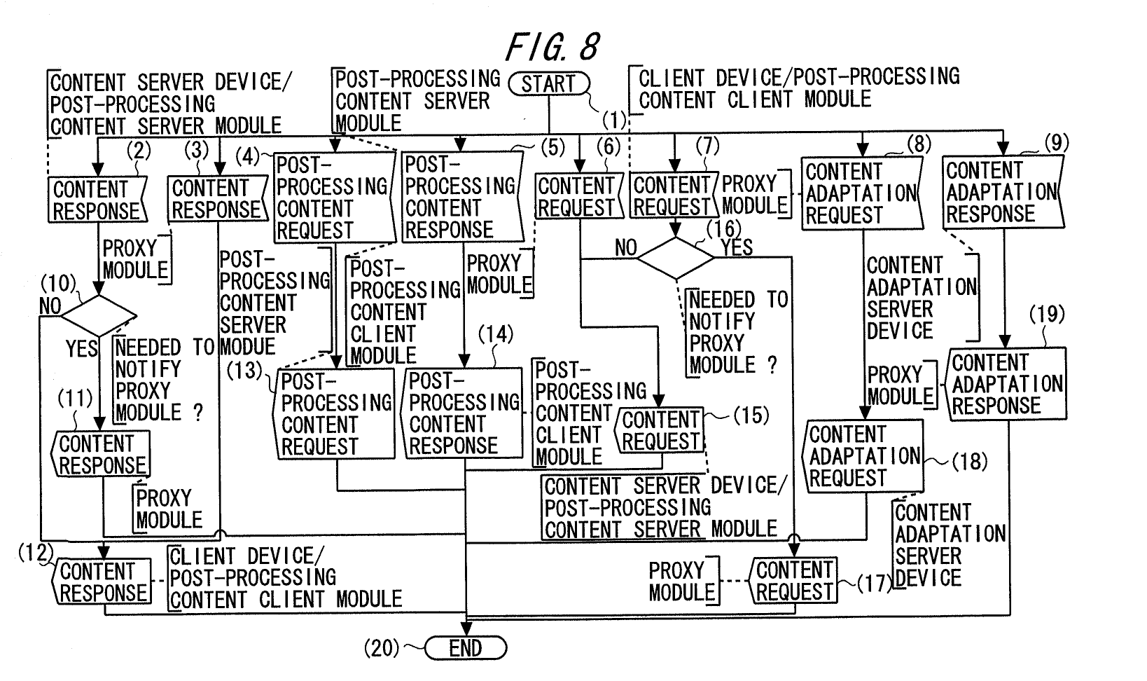

Next, operational examples of the content adaptation service control system 1 described above will be explained referring to FIGS. 1 through 27 in combination.

Each of the following operational examples will deal with the content adaptation processing of a Web content. In the discussion on each operation, the intermediary of the IP network NW is omitted unless specified otherwise. Moreover, in the description of each operational example, the bracketed numerals indicate the numbers of processing steps.

<Client Device C>

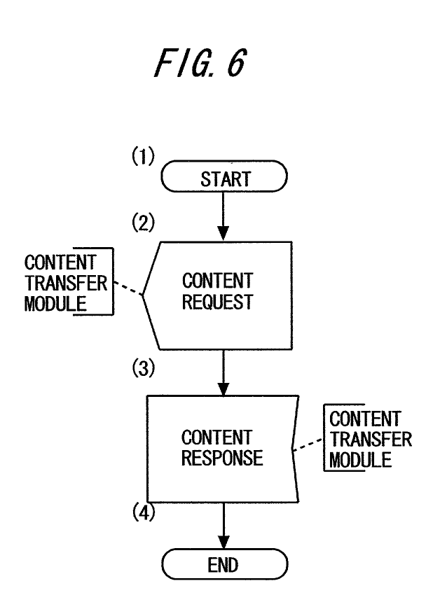

The client device C, when obtaining a desired content, as shown in FIG. 6, executes processes in steps (1) through (4) which follow:

(1) Start;

(2) Send the content acquisition request message (which will hereinafter be simply called a “content request” in some cases) to the content transfer module 21 of the edge device E1;

(3) Receive the content acquisition response message (which will hereinafter be simply called a “content response” in some cases) from the content transfer module 21 of the edge device E1; and

(4) End.

<Content Server Device CS>

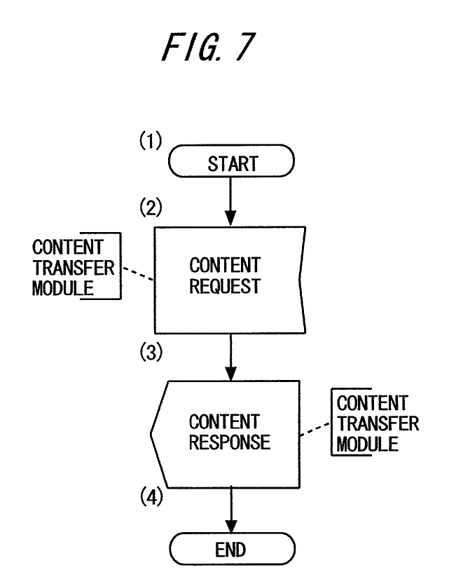

The content server device CS, when responding to the content request (when sending the requested content back), as shown in FIG. 7, executes processes in steps (1) through (4) which follow:

(1) Start;

(2) Receive the content acquisition request message from the content transfer module 21 of the edge device E1;

(3) Transmit the requested content as the content acquisition response message to the content transfer module 21 of the edge device E1; and

(4) End.

Note that precisely the content server device CS transmits and receives the information such as the message via the edge device E2, however, the intermediary of the edge device E2 is omitted unless specified otherwise.

<Content Transfer Module 21 of Edge Device E1>

The content transfer module 21 of the edge device E1, when receiving the information from other function modules within the same edge device or other devices (such as the client device C, the edge device E2, the content server device CS and the content adaptation server device CA), executes processes in steps (1) through (20) which follow:

(1) Start;

(2) Execute a process in (10) when receiving the content response from the content server device CS or the post-processing content server module 26 in the edge device E1;

(3) Execute a process in (12) when receiving the content response from the proxy module 24;

(4) Execute a process in (13) when receiving the post-processing content request from the post-processing content client module 25;

(5) Execute a process in (14) when receiving the post-processing content response from the post-processing content server module 26;

(6) Execute a process in (15) when receiving the content request from the proxy module 24;

(7) Execute a process in (16) when receiving the content request from the client device C or the post-processing content client module 25;

(8) Execute a process in (18) when receiving a content adaptation request from the proxy module 24;

(9) Execute a process in (19) when receiving a content adaptation response from the content adaptation server device CA;

(10) Judge whether or not the content response received needs transmitting to the proxy module 24. If judged “Yes”, execute a process in (11). Whereas if judged “No”, execute a process in (12);

(11) Transmit the content response to the proxy module 24, and execute a process in (20);

(12) Transmit the content response to the client device C or the post-processing content client module 25 in the edge device E1, and execute the process in (20);

(13) Transmit the post-processing content request to the post-processing content server module 26, and execute the process in (20);

(14) Transmit the post-processing content response to the post-processing content client module 25, and execute the process in (20);

(15) Transmit the content request to the content server device CS or the post-processing content server module 26, and execute the process in (20);

(16) Judge whether or not the content request received needs transmitting to the proxy module 24. If judged “Yes”, execute a process in (17). Whereas if judged “No”, execute the process in (15);

(17) Transmit the content request to the proxy module 24, and execute the process in (20);

(18) Transmit the content adaptation request to the content adaptation server device CA, and execute the process in (20);

(19) Transmit the content adaptation response to the proxy module 24, and execute the process in (20); and

(20) End.

<Proxy Module 24 of Edge Device E1 (Trigger Analyzing Process)>

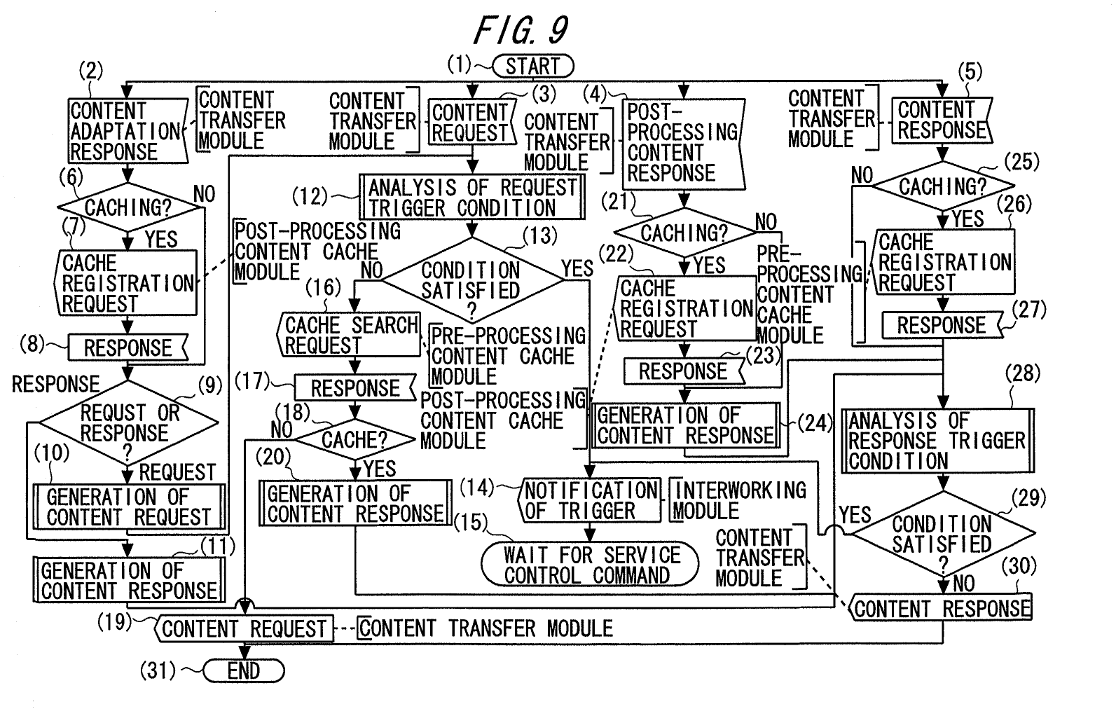

The proxy module 24 of the edge device E1, when analyzing the startup trigger of the content adaptation service on the basis of the information received from the content transfer module 21, as shown in FIG. 9, executes processes in steps (1) through (31) which follows:

(1) Start;

(2) Execute a process in (6) when receiving the content adaptation processing from the content transfer module 21;

(3) Execute a process in (12) when receiving the content request from the content transfer module 21;

(4) Execute a process in (21) when receiving the post-processing content response from the content transfer module 21;

(5) Execute a process in (25) when receiving the content response from the content transfer module 21;

(6) Judge whether or not the received content is cached or not on the basis of the service control command received before. If judged “Yes”, execute a process in (7). Whereas if judged “No”, execute a process in (9);

(7) Transmit a cache registration request to the post-processing content cache module 23;

(8) Receive the response;

(9) Judge whether what the content adaptation processing is applied to is the content request or the content response. If judged to be the content request, execute a process in (10) If judged to be the content response, execute a process in (11);

(10) Generate the content request, and execute a process in (12);

(11) Generate the content response, and execute a process in (28);

(12) Analyze a condition (a request trigger condition) as to whether the content adaptation processing to the content request is needed to be executed or not;

(13) Judge whether the request trigger condition is met. If judged “Yes”, execute a process in (14). Whereas if judged “No”, execute a process in (16);

(14) Transmit a trigger notification to the interworking module 20;

(15) Transit to a service control command standby status;

(16) Send a cache search request to the pre-processing content cache module 22 in order to check whether the request target content is cached;

(17) Receive a response from the pre-processing content cache module 22;

(18) Judge whether the pre-processing content has been cached. If judged “Yes”, execute a process in (20). Whereas if judged “No”, execute a process in (19);

(19) Send the content request to the content transfer module 21, and execute a process in (31);

(20) generate the content response by use of the cached pre-processing content, and execute a process in (28);

(21) Judge whether the received post-processing content is cached on the basis of the service control command received before. If judged “Yes”, execute a process in (22). Whereas if judged “No”, execute a process in (24);

(22) Transmit the cache registration request to the post-processing content cache module 23;

(23) Receive a cache registration response from the post-processing content cache module 23;

(24) Generate the content response, and execute a process in (28);

(25) Judge whether the received pre-processing content is cached. If judged “Yes”, execute a process in (26). Whereas if judged “No”, execute a process in (28);

(26) Transmit the cache registration request to the pre-processing content cache module 22;

(27) Receive a cache registration response from the pre-processing content cache module 22;

(28) Analyze a condition (a response trigger condition) as to whether the content adaptation processing for the content response is needed to be executed or not;

(29) Judge whether the response trigger condition is met or not. If judged “Yes”, execute the process in (14). Whereas if judged “No”, execute a process (30);

(30) Transmit the content response to the content transfer module 21; and

(31) End.

<Proxy Module 24 of Edge Device E1 (Service Control Command Receiving Process)>

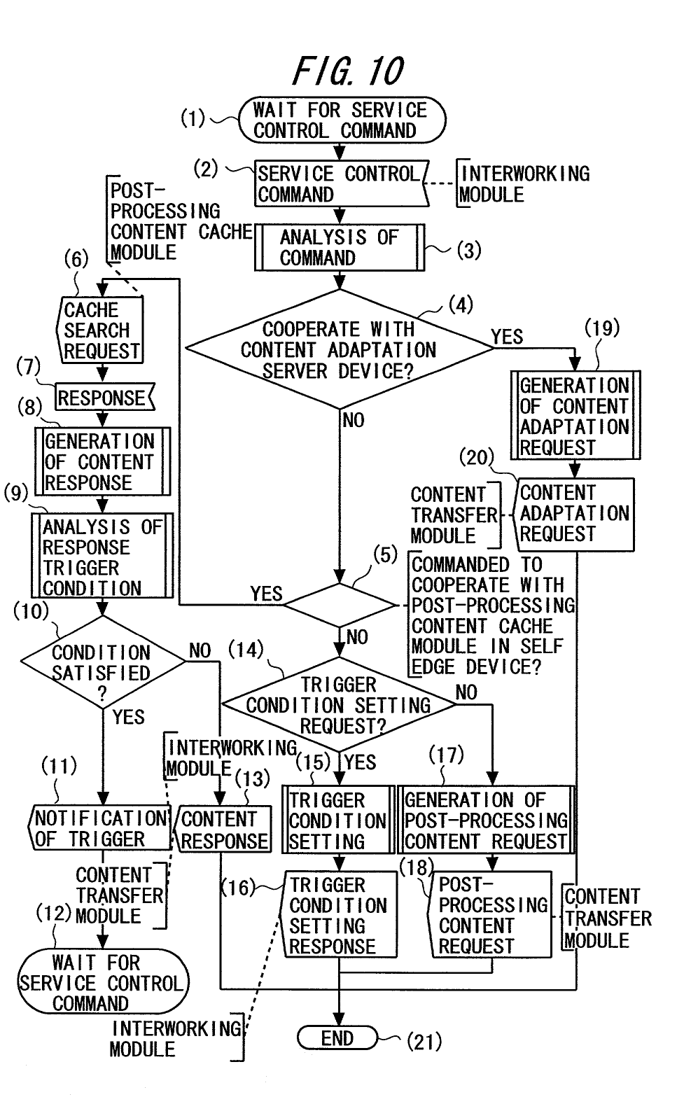

The proxy module 24 of the edge device E1, when receiving a service control command from the service control device SC via the interworking module 20, as shown in FIG. 10, executes processes in steps (1) through (20) which follow:

(1) Be in a service control command standby status;

(2) Receive the service control command from the interworking module 20;

(3) Analyze the service control command;

(4) Judge whether the service control command requests an execution of the content adaptation processing. If judged “Yes”, execute a process in (19). Whereas if judged “No”, execute a process in (5);

(5) Judge whether the service control command requests the use of the post-processing content cache retained in the self edge device E1. If judged “Yes”, execute a process in (6). Whereas if judged “No”, execute a process in (14);

(6) Transmit a cache search request to the post-processing content cache module 23;

(7) Receive a cache search response from the post-processing content cache module 23;

(8) Generate a content response by use of the post-processing content cache that has been cached so far;

(9) Analyze the response trigger condition;

(10) Judge whether the response trigger condition is satisfied. If judged “Yes”, execute a process in (11). Whereas if judged “No”, execute a process in (13);

(11) Transmit the trigger notification to the interworking module 20;

(12) Transit to the service control command standby status;

(13) Send the content response to the content transfer module 21, and execute a process in (21);

(14) Judge whether the service control command requests setting of the trigger condition. If judged “Yes”, execute a process in (15). Whereas judged “No”, execute a process in (17);

(15) Set the trigger condition;

(16) Send a trigger condition setting response to the interworking module 20, and execute a process in (21);

(17) Generate, because of the service control command requesting an acquisition of the post-processing content retained in the post-processing content server module 26 in other edge device, a post-processing content request to be sent to the post-processing content server module 26 in this edge device;

(18) Transmit the post-processing content request to the content transfer module 21;

(19) Generate a content adaptation request to be sent to the content adaptation server device CA;

(20) Send the content adaptation request to the content transfer module 21; and

(21) End.

<Interworking Module 20 of Edge Device E1 (Notifying Process to Service Control Device SC)>

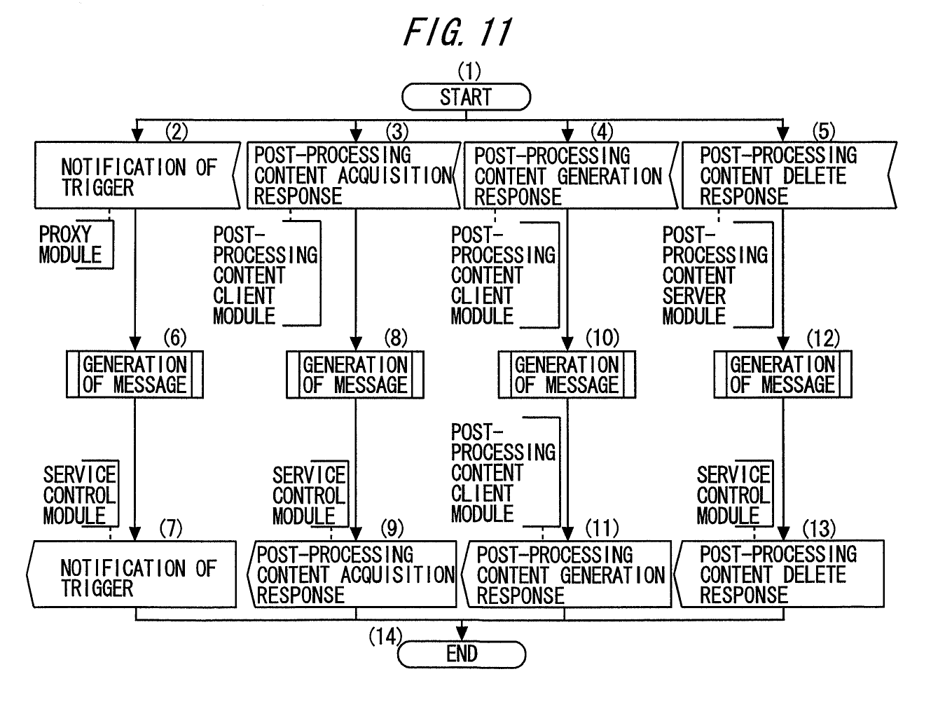

The interworking module 20 of the edge device E1, when receiving an interwork request with the service control device SC from the proxy module 24, as shown in FIG. 11, executes processes in steps (1) through (14) which follow:

(1) Start;

(2) Execute a process in (6) when receiving a trigger notification from the proxy module 24;

(3) Execute a process in (8) when receiving a post-processing content acquisition response from the post-processing content client module 25;

(4) Execute a process in (10) when receiving a post-processing content generation response from the post-processing content client module 25;

(5) Execute a process in (12) when receiving a post-processing content delete response from the post-processing content server module 26;

(6) Generate a message to be sent to the service control module 10 of the service control device SC;

(7) Send the trigger notification to the service control module 10, and execute a process in (14);

(8) Generate a message to be sent to the service control module;

(9) Send the post-processing content acquisition response to the service control module 10, and execute the process in (14);

(10) Generate a message to be sent to the service control module;

(11) Send a post-processing content generation response to the service control module 10;

(12) Generate a message to be sent to the service control module;

(13) Send a post-processing content delete response to the service control module 10; and

(14) End.

<Interworking Module 20 of Edge Device E1 (Service Control Command Receiving Process>

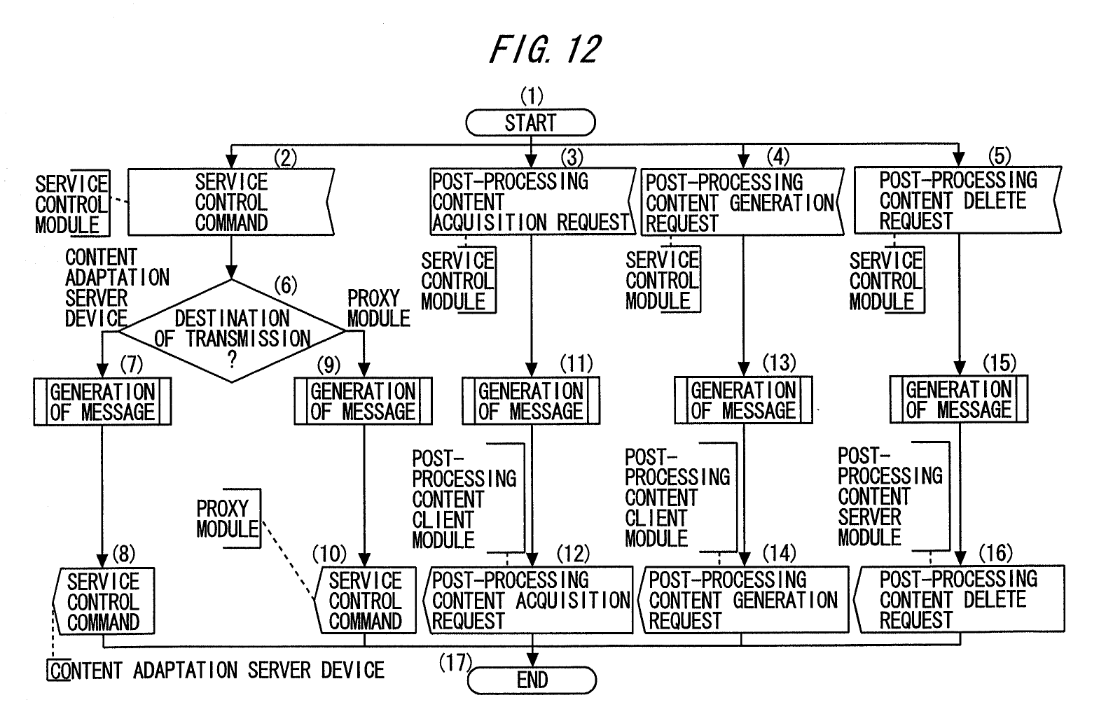

The interworking module 20 of the edge device E1, when receiving the service control command from the service control module 10 of the service control device SC, as shown in FIG. 12, executes processes in steps (1) through (17) which follow:

(1) Start;

(2) Execute a process in (6) when receiving the service control command from the service control module 10;

(3) Execute a process in (11) when receiving a post-processing content acquisition request from the service control module 10;

(4) Execute a process in (13) when receiving a post-processing content generation request from the service control module 10;

(5) Execute a process in (15) when receiving a post-processing content delete request from the service control module 10;

(6) Judge a destination to which the received service control command is transmitted. If the destination of transmission is the content adaptation server device CA, execute a process in (7). If being the proxy module 24, execute a process in (9);

(7) Generate a message to be transmitted to the content adaptation server device CA;

(8) Transmits the service control command to the content adaptation server device CA, and execute a process in (17);

(9) Generate a message to be transmitted to the proxy module 24;

(10) Transmits the service control command to the proxy module 24, and execute the process in (17);

(11) Generate a message to be transmitted to the post-processing content client module 25;

(12) Transmit a post-processing content acquisition request to the post-processing content client module 25, and execute the process in (17);

(13) Generate a message to be transmitted to the post-processing content client module 25;

(14) Transmit a post-processing content generation request to the post-processing content client module 25;

(15) Generate a message to be transmitted to the post-processing content server module 26;

(16) Transmit a post-processing content delete request to the post-processing content server module 26; and

(17) End.

<Trigger Setting Process of Service Control Device SC>

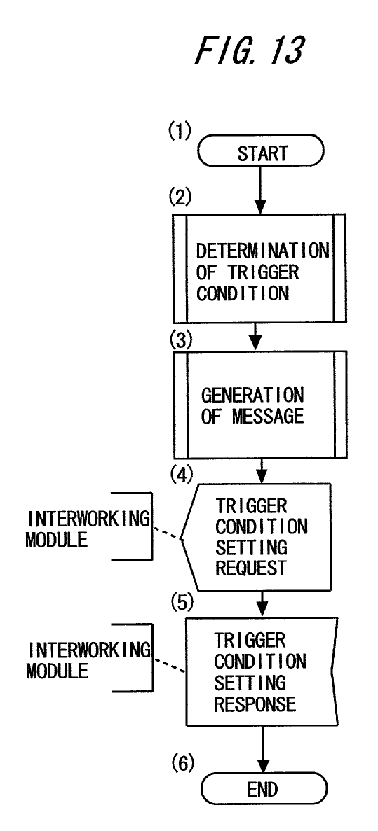

The service control device SC, when setting trigger conditions for the content adaptation process in the edge device E1, as shown in FIG. 13, executes processes in steps (1) through (6) which follow:

(1) Start;

(2) Determine the trigger condition. Items set as the trigger conditions are an address of the client device C, a piece of information indicating which is a target, the content request or the content response, the content adaptation processing is applied to, a condition related to an attribute of the content (the condition is that a content description language must be other than, for instance, Japanese), and an address of a trigger condition setting target edge device. Note that the trigger condition setting target edge device is the edge device E1 including the client device C;

(3) Generate a message to be transmitted to the interworking module 20;

(4) Send a trigger condition setting request to the interworking module 20. Note that this trigger condition setting request is transferred as a service control command to the proxy module 24 via the interworking module 20;

(5) Receive a trigger condition setting response from the interworking module 20; and

(6) End.

<Trigger Notification Receiving Process of Service Control Device SC>

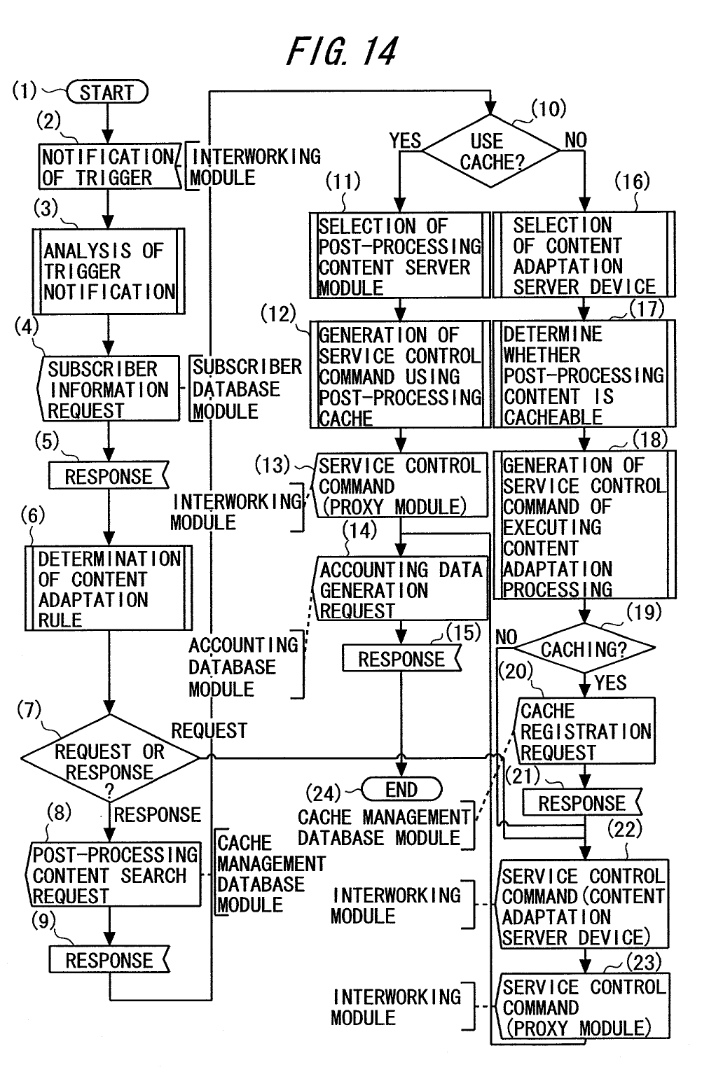

The service control device SC, when receiving a service startup trigger from the edge device E1, as shown in FIG. 14, executes processes in steps (1) through (24) which follow. Note that the trigger condition setting has, it is assumed, been completed by the trigger setting process described above (In the following operational examples, it is assumed that the trigger setting has been completed unless specified otherwise)

(1) Start;

(2) Receive the trigger notification from the interworking module 20;

(3) Analyze the trigger notification;

(4) Transmit a subscriber information request to the subscriber management database 12;

(5) Receive a subscriber information response from the subscriber management database 12;

(6) Determine the content adaptation rule on the basis of the trigger notification information and the subscriber information;

(7) Judge which is the processing execution target, the content request or the content response. If judged to be the content request, execute a process in 22). If judged to be the content response, execute a process in (8);

(8) Transmit a post-processing content search request to the cache management database 13;

(9) Receive a post-processing content search response from the cache management database 13. A result of these arch response leads to acquisitions of whether there is the post-processing cache, a post-processing content ID if the cache exists, a server ID (a list of server IDs) of the server that manages the cache, an effective period of the cache, and an update date/time of the pre-processing content serving as a basis for creating the post-processing content;

(10) Judge whether the cache is used or not. What can be considered as criteria for this judgement is knowing whether the post-processing content cache exists in the present control target edge device, judging whether a new post-processing content cache is generated in the control target edge device even when the post-processing content cache exists in other edge device, judging whether the existing post-processing content cache is old enough to be unusable, detecting whether a fault occurs in the edge device that retains the post-processing content cache, and so on. A specific criterion for determining whether this judgement is made or not is not, however, shown herein. Note that if the post-processing content cache does not exist, the cache is judged unusable. If judged “Yes”, execute a process in (11). Whereas if judged “No”, execute a process in (16);

(11) Select the post-processing content server module 26 retaining the post-processing content as the cache. Note that if a plurality of post-processing content server modules 26 are provided, one of these modules 26 is selected. What can be considered as a selection criterion in this case involves the use of a distance from the present control target edge device and a state of load of the post-processing content server module 26;

(12) Generate the service control command for utilizing the existing post-processing content cache. In this case, if the post-processing content is not cached in the control target edge device, it is specified whether the post-processing content be cached in this edge device;

(13) Transmit the service control command to the interworking module 20. The service control command is then transmitted to the proxy module 24 via the interworking module 20;

(14) Send an accounting data generation request to the accounting database 14 when charging a fee for using the post-processing content cache;

(15) Execute a process in (24) when receiving an accounting data generation response from the accounting database 14;

(16) Select the content adaptation server device CA to be used when executing the content adaptation processing. If there exist the plurality of content adaptation server devices CA, one of these devices CA is chosen. What can be considered as a selection criterion in this case involves the use of a distance from the present control target edge device and a state of load of the content adaptation server device CA;

(17) Determine whether the post-processing content obtained from the result of executing the content adaptation processing, is cached in the post-processing content cache module 23 within the edge device E1;

(18) Generate the service control command for executing the content adaptation processing. In this case, it is specified whether the post-processing content determined in (17) is cacheable or not;

(19) Judge whether the post-processing content is judged to be cached in (17). If judge “Yes”, execute a process in (20). Whereas if judged “No”, execute a process in (22);

(20) Transmit the cache registration request to the cache management database 13;

(21) Receive the cache registration response from the cache management database 13;

(22) Transmit the service control command to the interworking module 20. This service control module is transmitted to the content adaptation server device CA via the interworking module 20;

(23) Transmit the service control command to the interworking module 20. This service control module is transmitted to the proxy module 24 via the interworking module 20. Execute the process in (14); and

(24) End.

<Post-Processing Content Acquisition Process of Service Control Device SC>

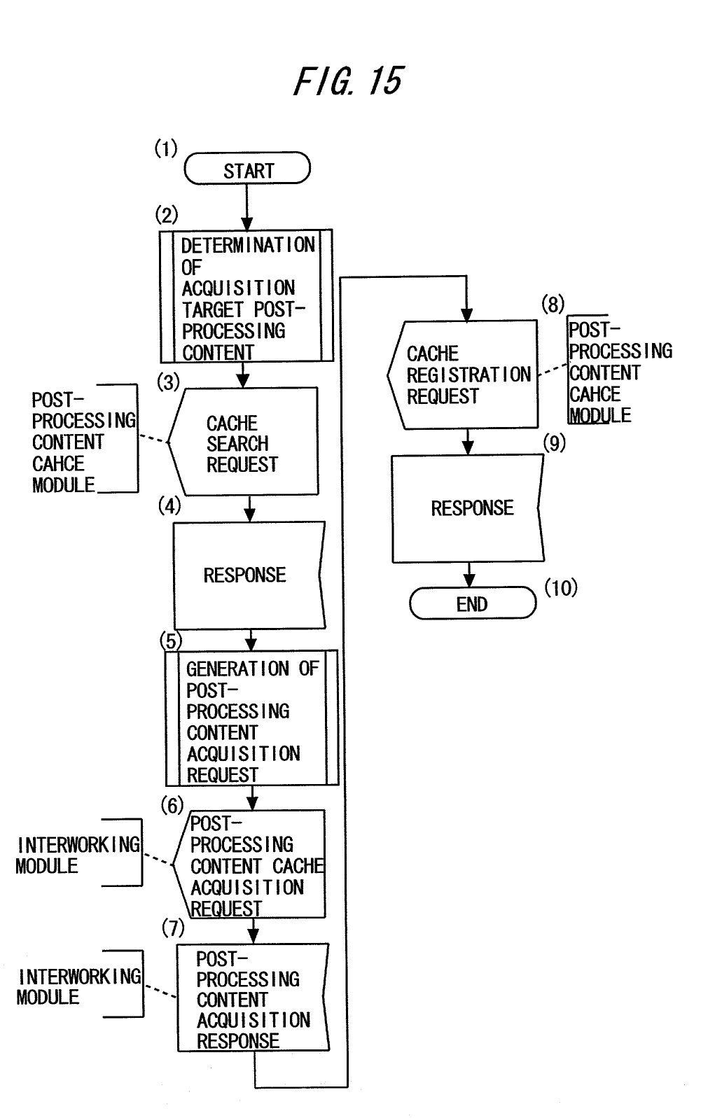

The service control device SC, when transferring the post-processing content retained in a certain edge device to a different edge device, as shown in FIG. 15, executes processes in steps (1) through (10) which follow:

(1) Start;

(2) Determine an acquisition target post-processing content;

(3) Transmit the cache search request to the cache management database 13 as the necessity arises;

(4) Receive the cache search response from the cache management database 13;

(5) Generate a message to be sent to the interworking module 20;

(6) Transmit the post-processing content acquisition request to the interworking module 20;

(7) Receive the post-processing content acquisition response from the interworking module 20;

(8) Transmit the cache registration request to the cache management database 13;

(9) Receive the cache registration response from the cache management database 13; and

(10) End.

<Post-Processing Content Delete Process of Service Control Device SC>

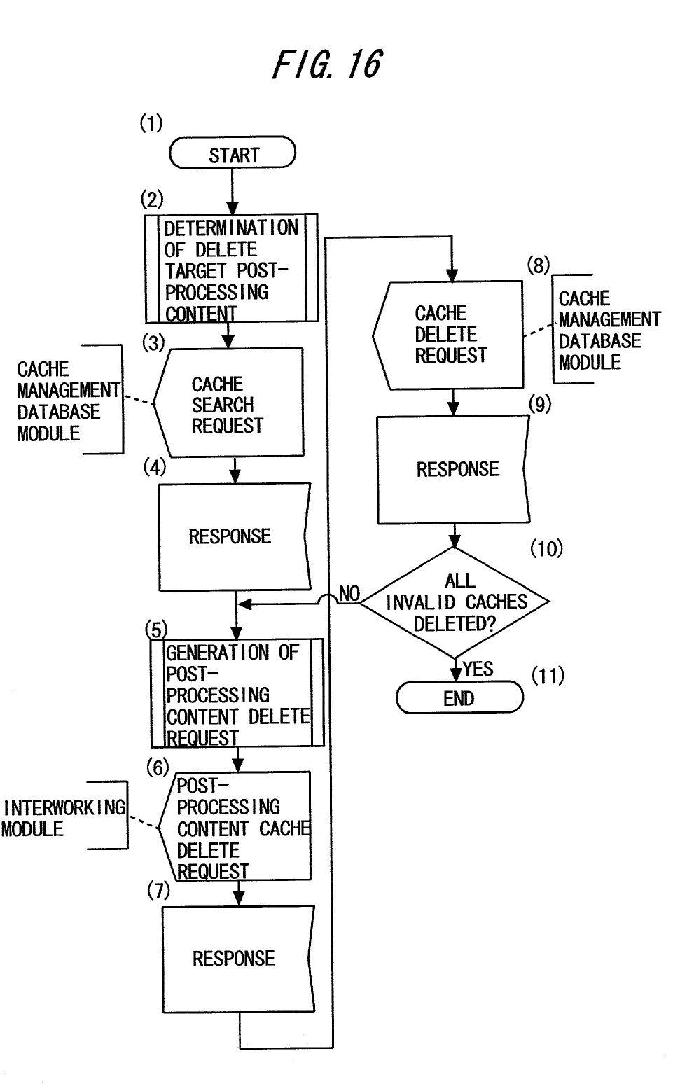

The service control device SC, when deleting the post-processing content retained in the edge device E1, as shown in FIG. 16, executes processes in steps (1) through (11) which follow:

(1) Start;

(2) Determine a delete target post-processing content;

(3) Transmit the cache search request to the cache management database 13 as the necessity arises;

(4) Receive the cache search response from the cache management database 13;

(5) Generate a message to be sent to the interworking module 20;

(6) Transmit a post-processing content delete request to the interworking module 20;

(7) Receive a post-processing content delete response from the interworking module 20;

(8) Transmit a cache delete request to the cache management database 13;

(9) Receive a cache delete response from the cache management database 13;

(10) Judge whether all the delete target post-processing contents have been deleted or not. If judged “Yes”, execute a process in (11). Whereas if judged “No”, execute the process in (5); and

(11) End.

<Post-Processing Content Generation Process of Service Control Device SC>

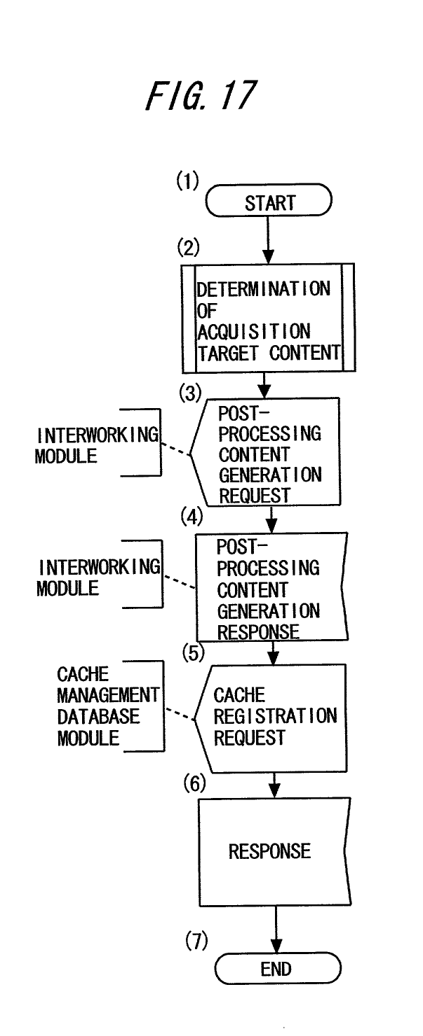

The service control device SC, when newly caching the post-processing content in the edge device by use of the pre-processing content retained in the content server device CS, as shown in FIG. 17, executes processes in steps (1) through (7) which follow:

(1) Start;

(2) Determine an acquisition target pre-processing content, what content adaptation processing is executed by use of this pre-processing content, a name given to the post-processing content and an edge device for caching this post-processing content. If necessary, a trigger needed for generating the post-processing content is set;

(3) Transmit a post-processing content generation request to the interworking module 20. In this case, the pre-processing content name, the post-processing content name and the edge, which are determined in (2), are specified;

(4) Receive a post-processing content generation response from the interworking module 20. Note the service control device SC, before receiving the post-processing content generation response, controls the edge device E1 and the content adaptation server device CA in order to generate the post-processing content. This procedure is, however, the same as the trigger receiving process described above and is therefore omitted herein;

(5) Transmit the cache registration request about the generated post-processing content to the cache management database 13;

(6) Receive the cache registration response from the cache management database 13; and

(7) End.

<Post-Processing Content Client Module 25 of Edge Device E1>

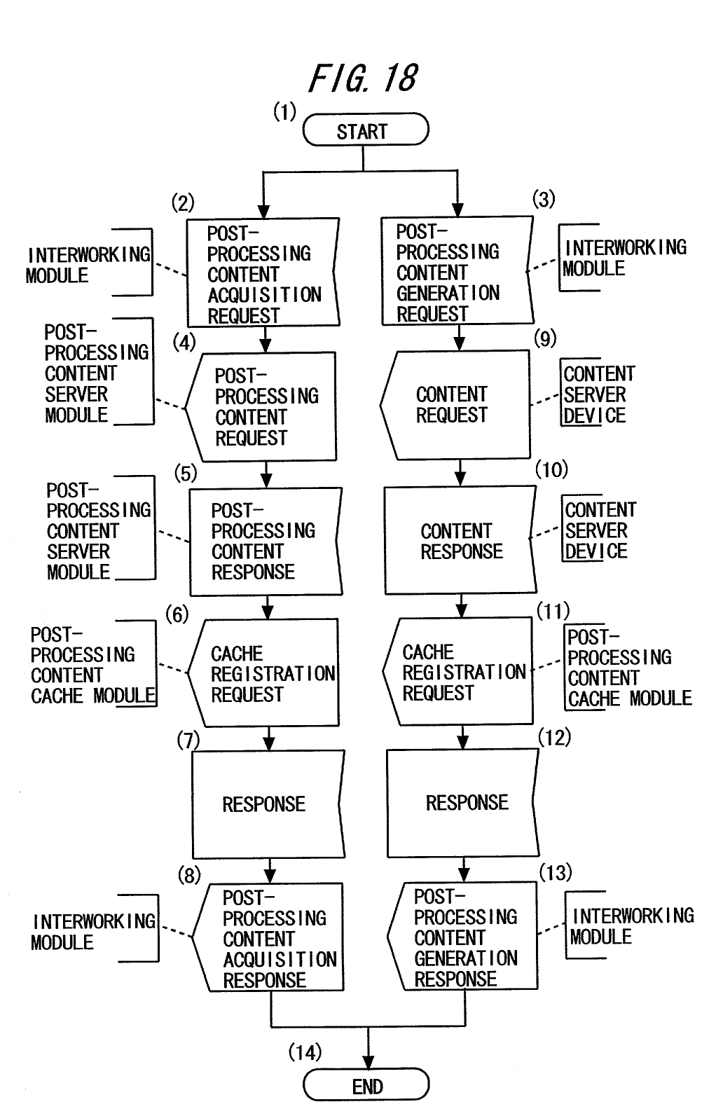

The post-processing content client module 25 of the edge device E1, when obtaining the post-processing content from the post-processing content server module 26 in other edge device or when obtaining the post-processing content by applying the content adaptation processing in the content adaptation server device CA in the process of acquiring the content from the content server device CS, as shown in FIG. 18, executes processes in steps (1) through (14) which follow:

(1) Start;

(2) Execute a process in (4) when receiving the post-processing content acquisition request from the interworking module 20;

(3) Execute a process in (9) when receiving the post-processing content generation request from the interworking module-20;

(4) Transmit the post-processing content request to the post-processing content server module 26;

(5) Receive the post-processing content response from the post-processing content server module 26;

(6) Transmit the cache registration request to the post-processing content cache module 23;

(7) Receive the cache registration response from the post-processing content cache module 23;

(8) Transmit the post-processing content acquisition response to the interworking module 20;

(9) Transmit the content request to the content transfer module 21;

(10) Receive the content response from the content transfer module 21. The content received is the post-processing content to which the content adaptation server device CA applies the content adaptation processing;

(11) Send the cache registration request of the acquired post-processing content to the post-processing content cache module 23;

(12) Receive the cache registration response from the post-processing content cache module 23;

(13) Transmit the post-processing content generation response to the interworking module 20; and

(14) End.

<Post-Processing Content Server Module 26 of Edge Device E1>

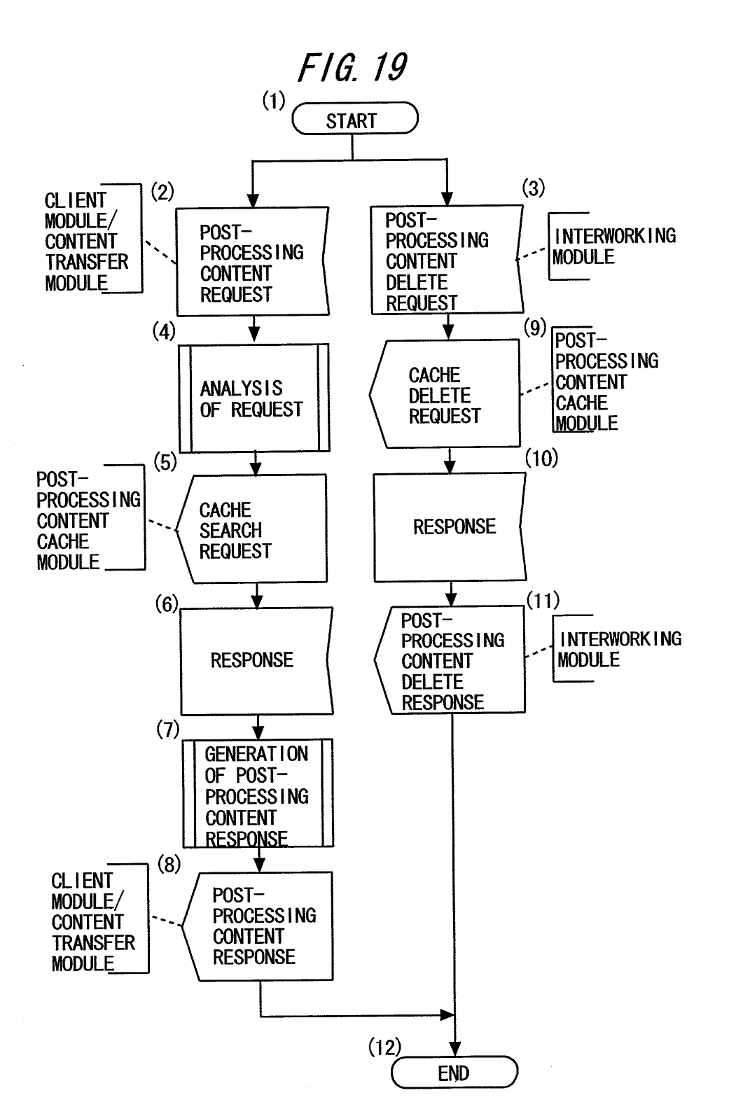

The post-processing content server module 26 of the edge device E1, when responding to a request given from the post-processing content client module 25 within other edge device, or a request, given from the content transfer module 21 in other edge device, for the cached post-processing content, this request occurring due to a conversion of a certain content request into a form adapted to the post-processing content request, or when deleting the post-processing content cached in the self-edge device E1 in response to a request from the service control device SC, as shown in FIG. 19, executes processes in steps (1) through (12) which follow:

(1) Start;

(2) Execute a process in (4) when receiving the post-processing content from the content transfer module 21 or the post-processing content client module 25;

(3) Execute a process in (9) when receiving the post-processing content delete request from the interworking module 20;

(4) Analyze the post-processing content request;

(5) Transmit the cache search request to the post-processing content cache module 23;

(6) Receive the cache search response from the post-processing content cache module 23;

(7) Generate a message to be transmitted to a requester;

(8) Send a post-processing content response to a source of transmission, and execute a process in (12);

(9) Send a cache delete request to the post-processing content cache module 23;

(10) Receive a cache delete response from the post-processing content cache module 23;

(11) Transmit a post-processing content delete response to the interworking module 20; and

(12) End.

<Content Process of Content Adaptation Server Device CA>

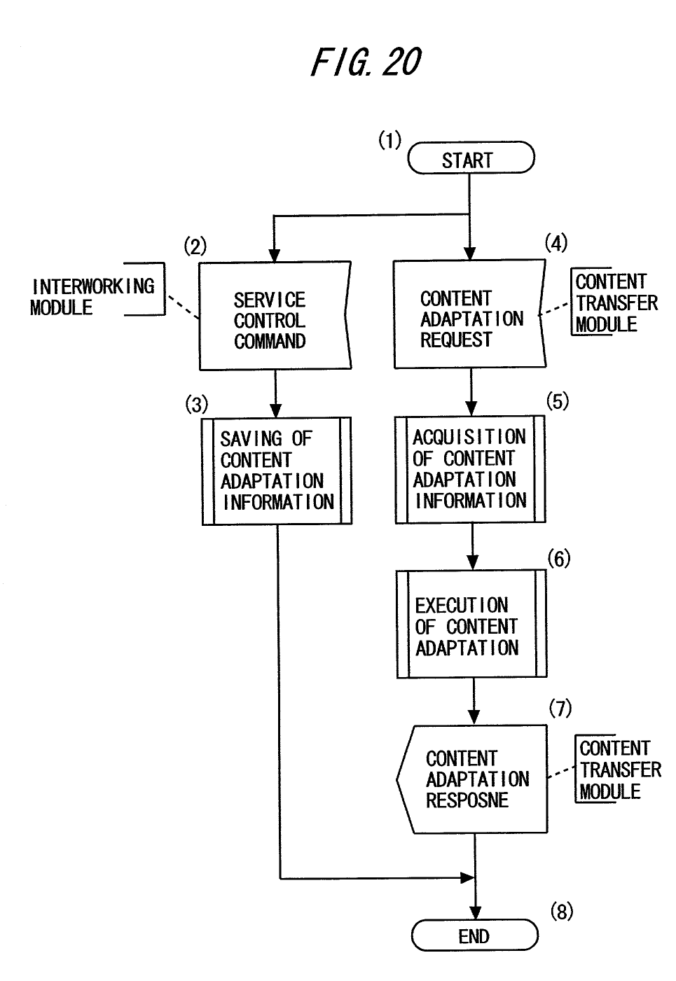

The content adaptation server device CA, when executing the content adaptation processing, as shown in FIG. 20, executes processes in steps (1) through (8) which follow:

(1) Start;

(2) Receive the service control command from the interworking module 20;

(3) Save information on the content adaptation processing, and execute a process in (8);

(4) Receive a content adaptation request from the content transfer module 21;

(5) Acquire the content adaptation information saved in (3);

(6) Execute the content adaptation processing based on the content adaptation information;

(7) Send a content adaptation response to the content transfer module 21; and

(8) End.

<First Operational Example of Content Adaptation Service: Content Adaptation Processing to Content Request>

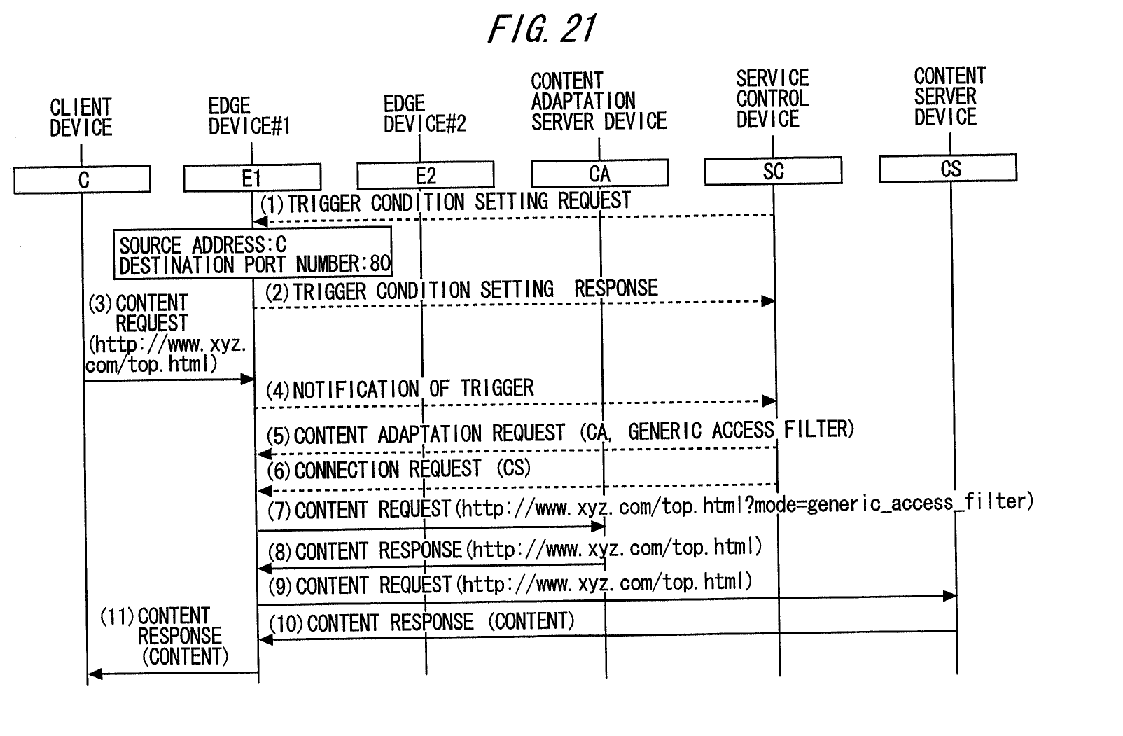

FIG. 21 is a sequence chart showing the content adaptation processing to the content (acquisition) request as an operational example of the content adaptation service in the content adaptation service control system SYS.

Herein, an access filter service is exemplified as an example of executing the content adaptation processing to the content request given to the content server device CS from the client device C.

(1) The service control device SC sets a trigger condition in the edge device (#1) E1 including the client device C. Herein, the trigger condition is that an address [C] of the client device C subscribing the access filter service is set as a source address, and [80] for identifying a port based on HTTP protocol is set as a destination TCP port number;

(2) The edge device E1 responds to the setting of the trigger condition requested in (1);

(3) The client device C transmits the content request of the content specified by URL [http://www.xyz.com/top.html] to the content server device CS;

(4) The edge device E1 analyzes the content request received. The edge device E1, when detecting that the trigger condition is satisfied, sends this purport to the service control device SC;

(5) The service control device SC selects, in a way that considers a location of the client device C and a load of the content adaptation server device CA, the content adaptation server device CA optimal for applying the access filter service with respect to this content request. Herein, it is presumed that the content adaptation server device CA having an address [CA] has been selected.

Further, detailed filter conditions (such as an access-from-the-minor inhibiting site and so on) are obtained from the subscriber management database 12 according to the necessity. Thereafter, the address {CA} of the content adaptation server device CA and the content adaptation rule information (which is herein the generic access filter) are transmitted as a content adaptation request to the edge device E1.

Note that the edge device E1 receiving the content adaptation request may transfer the content adaptation request to the content adaptation server device CA notified, however, a scheme is herein that the content adaptation target content request transmitted in (7) and the content adaptation rule information notified in the content adaptation request, are notified together (which is the same in all the following operational examples);

(6) The service control device SC request the content server device CS having an address [CS] to establish a connection. Note that in this case the content server device CS having an address [CS′] exists as a mirror server of the content server device CS having the address [CS]. When desiring to transfer the content request to the content server device CS having the address [CS′] for load sharing, the service control device SC may notify of [CS′] as a connection destination address;

(7) The edge device E1 transmits the content adaptation rule (the generic access filter) notified in (5) to the content adaptation server device CA having the address [CA], in which the content request embedded posterior to URL.

Herein, ICAP is applied as a protocol for interworking the edge device E1 and the content adaptation server CA with each other. In this case, the edge device E1 serves as an ICAP client, while the content adaptation server device CA serves as an ICAP server;

(8) The content adaptation server device CA, when recognizing that the generic access filter service is requested, applies the access filter to the content request (in this case, an assumption is the access filter has been passed through). The content adaptation server device CA transmits to the edge device E1 the content request from which the content adaptation rule embedded in URL is deleted;

(9) The edge device E1 transmits to the content server device CS the content request received as a result of the content adaptation processing from the content adaptation server device CA;

(10) The content server device transmits the requested content as a response back to the edge device E1; and

(11) The edge device E1 judges whether a certain item of trigger condition is satisfied by the received content response. An assumption herein is that the trigger condition is not met. The edge device E1, when recognizing that the trigger condition is not met, sends the content response to the client device C.

<Second Operational Example of Content Adaptation Service: Content Adaptation Processing (Cache Unused) Related to Content Response>

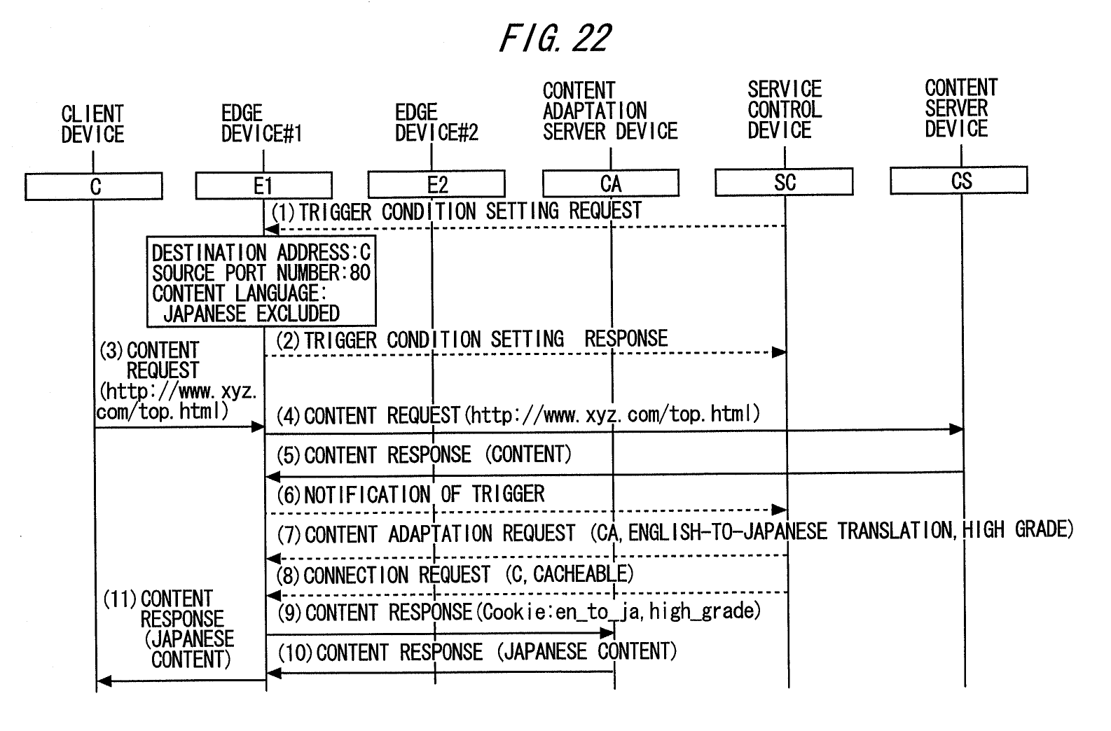

FIG. 22 is a sequence chart showing the content adaptation processing (using no cache) related to the content response as an operational example of the content adaptation service in the content adaptation service control system SYS.

Herein, a Japanese translation service of a content in English version is exemplified as an example of executing the content adaptation processing related to the content response sent from the content server device CS in response to a request from the client device C.

(1) The service control device SC sets a trigger condition in the edge device (#1) E1 including the client device C. Herein, the trigger condition is that an address [C] of the client device C subscribing the an English-to-Japanese translation service is set as a destination address, [80] for identifying a port based on HTTP protocol is set as a source TCP port number, and a content description language is not Japanese;

(2) The edge device E1 responds to the setting of the trigger condition requested in (1);

(3) The client device C transmits the content request of the content specified by URL [http://www.xyz.com/top.html] to the edge device E1;

(4) The edge device E1 receives the content request sent from the client device C, and judges whether a certain item of trigger condition is satisfied by this content request. The assumption herein is that the trigger condition is not met, however, if the trigger shown in the first operational example of the content adaptation service is set, the access filter service is started up.

The edge device E1, when recognizing that the trigger condition is not met, transmits the content request to the content server device CS. Herein, the edge device E1, if the trigger condition is that the address [C] of the client device C is set as a destination address and [80] is set as a source port number, registers this content request in a buffer (not shown) (which is the same in all the following operational examples);

(5) The content server device CS transmits the requested English content as a response back to the edge device E1;

(6) The edge device E1 analyzes the content response received. Conditions concerning the content description language are analyzed by examining an HTTP Content-Language header. The edge device E1, when detecting that the trigger condition is satisfied, transmits this purport to the service control device SC. In this case, the content request stored in the buffer in (4) is also transmitted simultaneously to the service control device SC;

(7) The service control device SC selects the content adaptation server device CA optimal for applying the English-to-Japanese translation with respect to the content response by referring to the subscriber management database 12.

Further, detailed translation optional conditions (such as a category and a grade of a dictionary used for the translation, and so on) are obtained from the subscriber management database 12 as the necessity arises. Thereafter, an address [CA] of the content adaptation server device CA and the content adaptation rule information (which herein specifies the English-to-Japanese translation and “High” as the dictionary grade) are transmitted as the content adaptation request to the edge device E1;

(8) The service control device SC requests the client device C having the address [C] to establish a connection. In this case, the service control device SC simultaneously specifies as to whether the post-processing content in the English-to-Japanese translated version is cached or not.

In this example, if cached, the service control device SC registers, in the cache management database 13, URL [http://www.xyz.com/top.html] of the pre-processing content, the content adaptation rule (specifying the English-to-Japanese translation and the dictionary grade), URL [http://www.xyz.com/top/ja.html] for specifying the post-processing content generated from the result of applying the content adaptation rule to the pre-processing content, and an address [E1] of the edge device E1 for managing the post-processing content cache;

(9) The edge device E1 transmits, to the content adaptation server device CA having the address [CA], the content response in which the content adaptation rule (the English-to-Japanese translation and the high-grade dictionary) notified in (7) is embedded as a Cookie;

(10) The content adaptation server device CA, when recognizing that the English-to-Japanese service using the high-grade dictionary is requested, applies the English-to-Japanese translation to the content response. The content adaptation server device CA sets the content description language to Japanese, and transmits the content response with the Cookie information deleted therefrom to the edge device E1; and

(11) The edge device E1 transmits to the client device C the content response received as a result of the content adaptation processing from the content adaptation server device CA.

<Third Operational Example of Content Adaptation Service: Content Adaptation Processing (Using Cache in Self Edge Device) Related to Content Response>

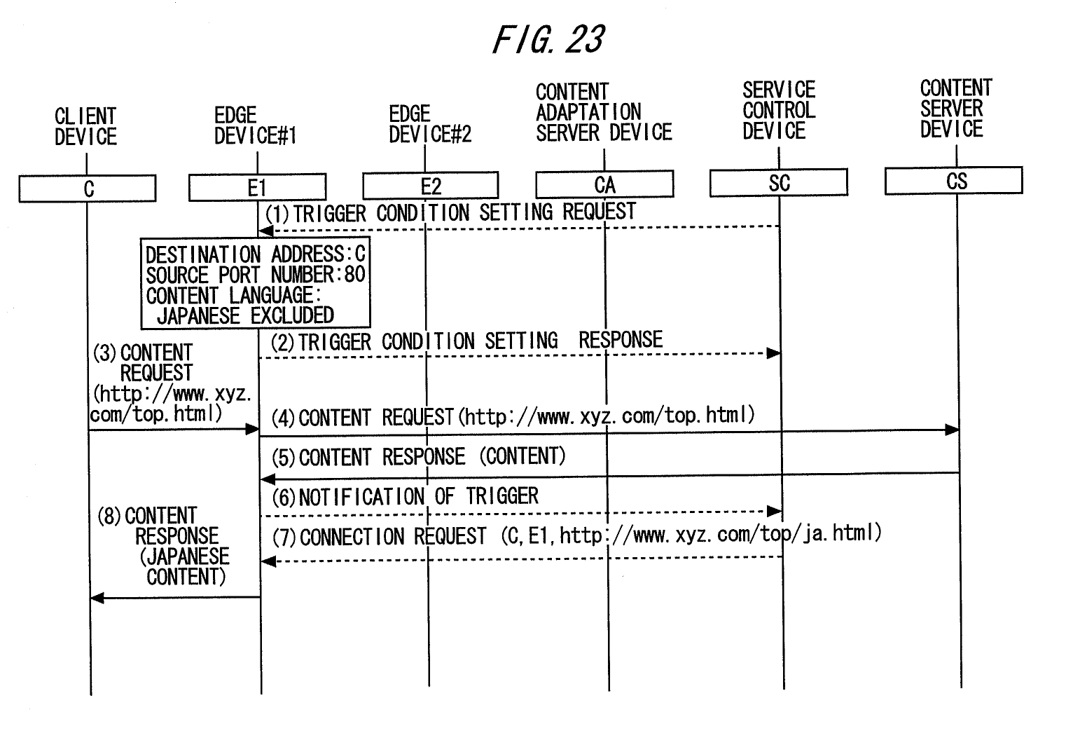

FIG. 23 is a sequence chart showing the content adaptation processing (using a cache in the self edge device) related to the content response as an operational example of the content adaptation service in the content adaptation service control system SYS.

Herein, the English-to-Japanese translation service as the second operational example of the content adaptation service, is exemplified by giving a case of actualizing this service utilizing the post-processing content.

(1)-(6) These steps (1) through (6) are the same as those in the second operational example of the content adaptation service described above. An assumption herein is that the pre-processing content is not cached in the edge device E1;

(7) The service control device SC determines the content adaptation rule in the same processing steps as those in the second operational example of the content adaptation service, and thereafter searches the cache management database 13, wherein URL [http://www.xyz.com/top.html] set in the information notified in (6) and the content adaptation rule, are used as key information.

The service control device SC, upon detecting an existence of the effective post-processing content concerned as a result of searching, selects the edge device E1 optimal for retaining the post-processing content. If the edge device (#1) E1 as a present control target set by the service control device SC retains the post-processing content, this edge device E1 becomes the optimal edge device. In other cases, the service control device SC selects the optimal edge device in a way that takes a distance from the edge device into consideration.

What is assumed in this example is a case where the edge device (#1) E1 retains the post-processing content, i.e., a case where the processing in the third operational example is carried out after executing the processing shown in the second operational example of the content adaptation service. Therefore, the service control device SC selects the edge device (#1) E1 as the optimal edge device.

The service control device SC, when requesting the client device C to connect, notifies the client device C of the address [E1] of the edge device E1 retaining the post-processing content and URL [http://www.xyz.com/top/ja.html] of the post-processing content together;

(8) The edge device E1 analyzes the connection request and, when recognizing that the post-processing content retained in the self edge device is requested to be used, generates a content response to be sent back to the client device C by use of the post-processing content; and

(9) The edge device E1 transmits the generated content response to the client device C.

<Fourth Operational Example of Content Adaptation Service: Content Adaptation Processing (Using Cache in Other Edge Device) Related to Content Response>

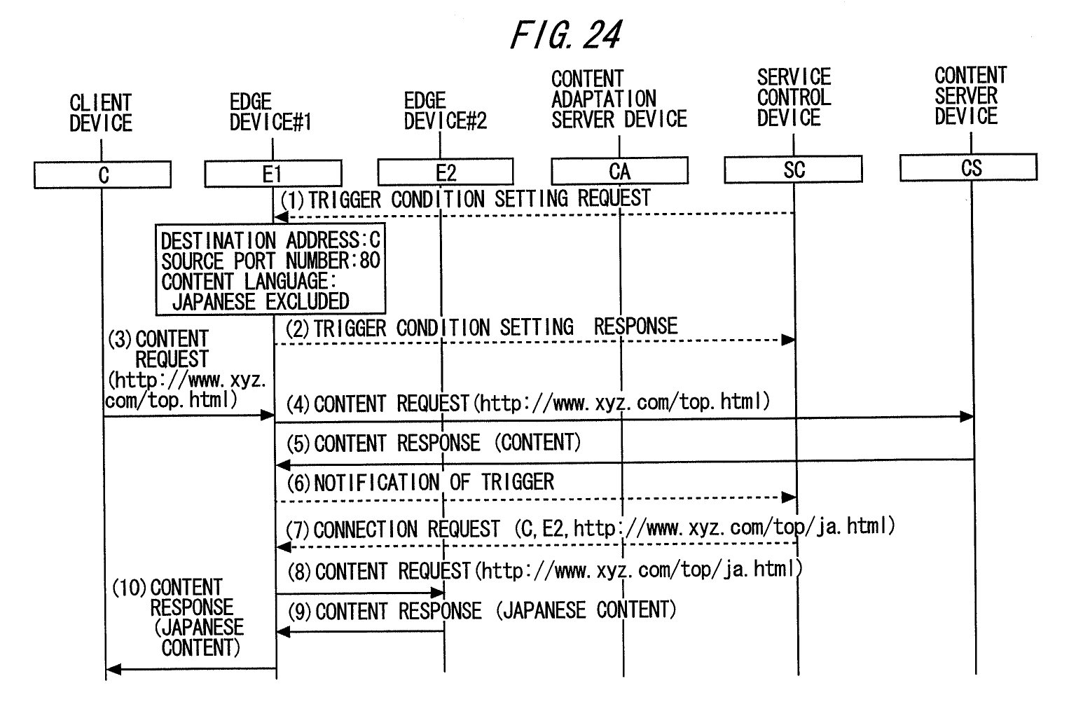

FIG. 24 is a sequence chart showing the content adaptation processing (using a cache in other edge device) related to the content response as an operational example of the content adaptation service in the content adaptation service control system SYS.

In this fourth operational example, there is exemplified a case that is the same as in the third operational example of the content adaptation service described above, wherein the post-processing content is not cached in the self edge device, however, the post-processing content cached in other edge device is utilized.

(1)-(6) These steps (1) through (6) are the same as those in the third operational example of the content adaptation service described above;

(7) The service control device SC determines the content adaptation rule in the same processing steps as those in the second operational example of the content adaptation service, and thereafter searches the cache management database 13, wherein URL [http://www.xyz.com/top.html] set in the information notified in (6) and the content adaptation rule, are used as key information.

The service control device SC, upon detecting an existence of the effective post-processing content concerned as a result of searching, selects the edge device optimal for retaining the post-processing content. If the edge device (#1) E1 as a present control target set by the service control device SC retains the post-processing content, this edge device E1 becomes the optimal edge device. In other cases, the service control device SC selects the optimal edge device in a way that takes a distance from the edge device into consideration.

What is assumed in this example is a case where the edge device E1 does not retain the post-processing content, and therefore the service control device SC selects an edge device (#2) E2 as the optimal edge device. The service control device SC, when requesting the client device C to connect, notifies the client device C of an address [E2] of the edge device E2 retaining the post-processing content and URL [http://www.xyz.com/top/ja.html] of the post-processing content together;

(8) The edge device E1 analyzes the connection request and, when recognizing that the post-processing content retained in the edge device E2 is requested to be used, transmits a content request to the edge device E2;

(9) The edge device E2 transmits the requested content as a response back to the edge device E1; and

(10) The edge device E1 transmits a content response generated by use of the post-processing content obtained from the edge device E2.

<Fifth Operational Example of Content Adaptation Service: Transfer of Post-Processing Content between Edge Devices>

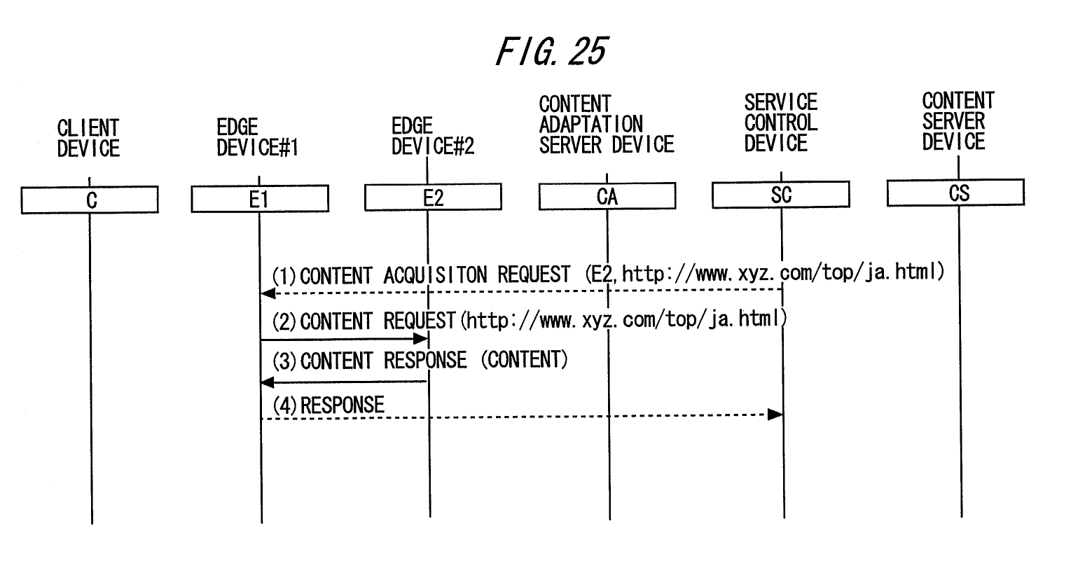

FIG. 25 is a sequence chart showing a case of transferring the post-processing content between the edge devices as an operational example of the content adaptation service in the content adaptation service control system SYS.

What is herein exemplified is a case in which the edge device (#1) E1 obtains the post-processing content cached in the edge device (#2) E2 and then caches this content in the self edge device E1 in response to a request given from the service control device SC.

(1) The service control device SC, when recognizing that the post-processing content is cached in the edge device E2 and is also to be cached in the edge device E1, notifies the edge device E1 of the address [E2] of the edge device E2 and URL [http://www.xyz.com/top/ja.html] of the post-processing content, and requests an acquisition of the content;

(2) The edge device E1, based on the information received from the service control device SC, generates the content request and transmits it to the edge device E2;

(3) The edge device E2 transmits the requested content as a response back to the edge device E1; and

(4) The edge device E1 stores in the self edge device the post-processing content obtained from the edge device E2. The edge device E1 notifies the service control device SC that the acquisition of the post-processing content is completed.

<Sixth Operational Example of Content Adaptation Service: Deletion of Post-Processing Content Cache in Edge Device>

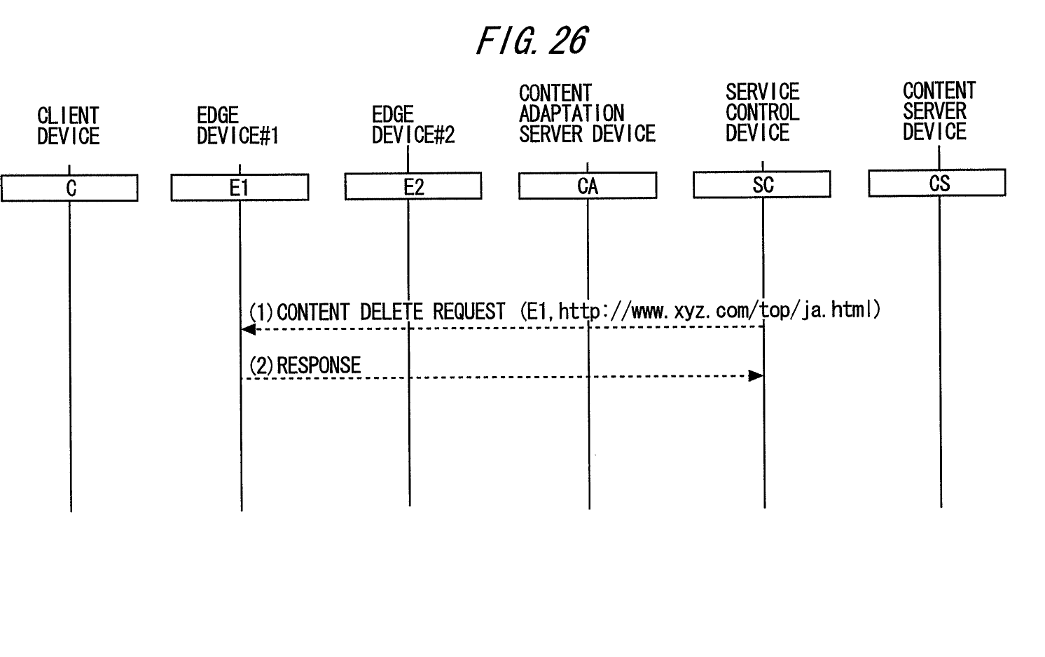

FIG. 26 is a sequence chart showing a case in which the service control device SC detects that a validity of the post-processing content is lost and deletes the post-processing content cache in the edge device E1 as an operational example of the content adaptation service in the content adaptation service control system SYS.

Herein, a possible scheme for the service control device SC to know an invalidity of the post-processing content, is that the content server device CS notifies that the content has been updated, or that the service control device SC controls the post-processing content client module 25 in the edge device E1 to query the content server device CS, or that the service control device SC itself queries the content server device CS.

(1) The service control device SC requests a deletion of the post-processing content existing in the edge device E1; and

(2) The edge device E1, when deleting the post-processing content specified by URL [http://www.xyz.com/top/ja.html], sends this purport as a response to the service control device SC. The service control device SC receiving this response updates the management information of the post-processing content in the cache management database 13.

<Seventh Operational Example of Content Adaptation Service: Generation of Network-Led Post-Processing Content>

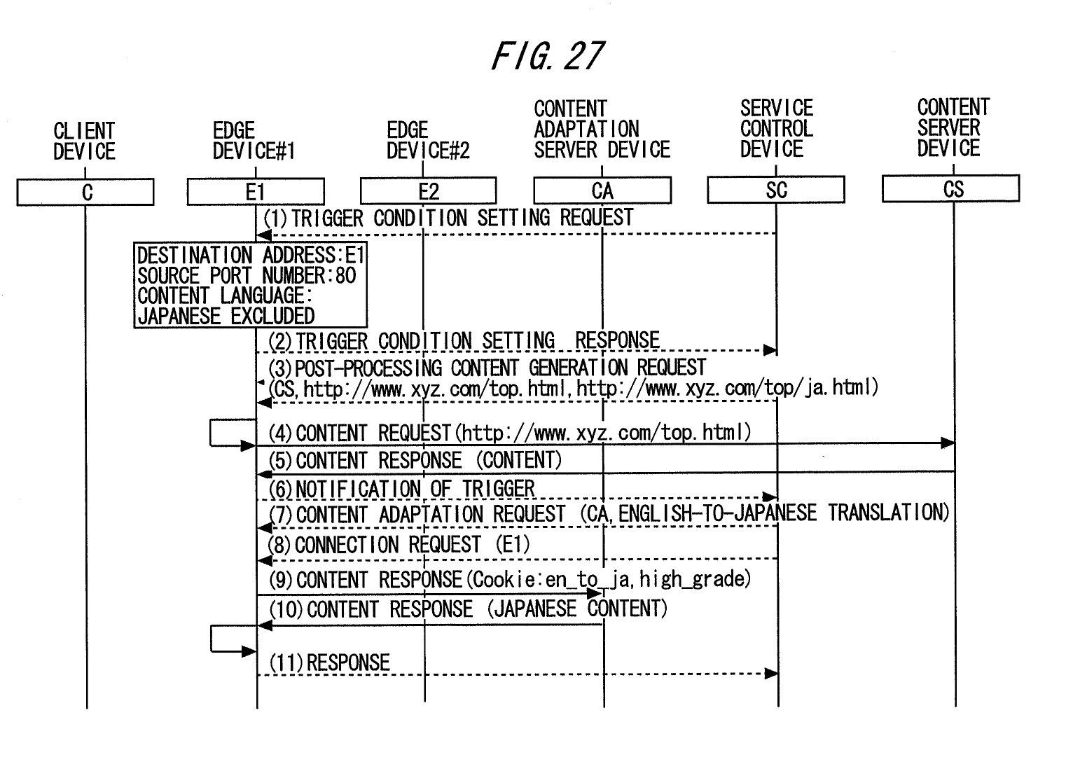

FIG. 27 is a sequence chart showing a case in which the service control device SC, with any one of the above schemes, detects that the post-processing content becomes invalid and newly generates an English-to-Japanese translation post-processing content without waiting for the request given from the client device C as an operational example of the content adaptation service in the content adaptation service control system SYS.

(1) The service control device SC sets, for the edge device E1, a trigger condition for a client function installed inside the edge device E1. Herein, the trigger condition is that an address [E1] of the client function is set as a destination address, [80] for identifying a port based on HTTP protocol is set as a source TCP port number, and a content description language is not Japanese;

(2) The edge device E1 responds to the setting of the trigger condition requested in (1);

(3) The service control device SC requests the client function in the edge device E1 to obtain a content. In this case, the service control device SC notifies the client function of URL [http://www.xyz.com/top.html] of the acquisition target content, an address [CS] of the content server device CS, and URL [http://www.xyz.com/top/ja.html] specifying the acquired post-processing content;

(4) The client function of the edge device E1 transmits the content request to the content server device CS via a proxy cache function of the edge device E1;

(5)-(9) Steps (5) through (9) are the same as steps (5) through (9) in the second operational example of the content adaptation service described above;

(10) The content adaptation server device CA, when recognizing that the English-to-Japanese translation service using the high-grade dictionary is requested, applies the English-to-Japanese translation to the content response. The content adaptation server device CA sets the content description language to Japanese, and transmits the content response with the Cookie information deleted to the edge device E1.

The edge device E1 transmits this content response to the client function in the self edge device. The client function receiving the content response registers the content the URL, notified in (3), for specifying the post-processing content and the post-processing content together in the cache; and

(11) The client function of the edge device E1 transmits the purport that the post-processing content has been obtained, as a response back to the service control device SC. The service control device SC receiving this response registers URL specifying the post-processing content, the address [E1] of the edge device E1 and the applied content adaptation rule in the cache management database 13.

### MODIFIED EXAMPLES

The respective processes in the embodiment discussed above can be provided as a program executable by a computer, recorded on a recording medium such as a CD-ROM, a flexible disk etc and distributed via communication lines.

Moreover, the respective processes in the embodiment discussed above can be carried out in a way that selects an arbitrary plurality of processes or all the processes and combines these processes.

According to the embodiment of the present invention described above, the interwork function defined as the function of interworking with the service control device SC is installed in only the edge device E1 but may also be installed in the content adaptation server device CA, whereby the service control device SC is, on the occasion of interworking with the content adaptation server device CA, capable of interworking directly with the content adaptation server device CA without through the edge device E1.

Further, the content adaptation processing is exemplified with respect to the cases applicable to all the contents, however, there might be a case where there exist contents to which the content adaptation processing can not be applied. In such a case, the edge device E1 judges an applicability of the content adaptation service by referring to the content attribute information, and may apply the content adaptation service only when the content adaptation processing is applicable.

The embodiment of the present invention has exemplified the English-to-Japanese Translation as a content adaptation mode, however, diversified content adaptation services can be provided using the same scheme by changing the functions incorporated into the content adaptation server device CA.

Other examples of the content adaptation service may be given such as an image/data compression adapted to the functions of the terminal (the client device C) utilized by the user and to a communication network (e.g., a narrow band wireless access network like a mobile communication network, a fixed telephone network, and a broadband access network like ADSL (Asymmetric Digital Subscriber Line) and so on) to which the user terminal is connected, an insertion of an advertisement suited to a favorite of the user, a conversion of a markup language (HTML, C-HTML etc) corresponding to the function of the mobile terminal utilized by the user, image processing (such as adding and removing mosaics and so forth), and corrections (a syntax check and marking of a test) of a document created by the user.

In the case of implementing these functions as the content adaptation services, items of information such as a type of the user's mobile phone, a category of the access network and an age thereof are managed as service subscription information in the database module 11 of the service control device SC. Including these examples of the service, whatever other categories of content adaptation processing may be implemented if executable within the same framework as in the present invention.

Further, based on the same framework as in the present invention, the content adaptation processing may be executed for the pre-processing content cache in the edge device E1.

Moreover, when a function held by a certain content adaptation server device CA is installed into the edge device E1, content adaptation processing executable by this function may be executed inside this edge device E1.

What is claimed is:

1. A content adaptation service control system provided with a content adaptation server device for carrying out a predetermined content adaptation service for original content data retained in a content server device in response to a content data acquisition request given from a client device utilized by a user, said system comprising:
an edge device, in a network, judging a necessity for, when receiving the content data acquisition request from said client device, starting the content adaptation service and notifying of a startup request; and
a service control device determining, when notified of the startup request from said edge device, a mode of the content adaptation service that should be carried out by said content adaptation server device on the basis of contract information about the user subscribing the content adaptation service, and transmitting the determined mode of the content adaptation service as a processing request to said edge device.

2. A content adaptation service control system according to claim 1, wherein said service control device determines the mode of the content adaptation service applied to the content data acquisition request transmitted from said client device, and makes a request for transferring the determined mode of the content adaptation service and the content data acquisition request to said content adaptation server device, and
said edge device transfers the determined mode of the content adaptation service and the content data acquisition request to said content adaptation service device in response to the request given from said service control device, receives from said content adaptation server device a post-processing content on which the content adaptation service is effected, then transfers the post-processing content to said content server device and acquires the original content data.

3. A content adaptation service control system according to claim 1, wherein said service control device determines the mode of the content adaptation service applied to the original content data transmitted from said content server device, and makes a request for transferring the determined mode of the content adaptation service and the original content data transmitted from said content server device to said content adaptation server device, and
said edge device transfers the determined mode of the content adaptation service and the original content data to said content adaptation service device in response to the request given from said service control device, receives from said content adaptation server device a post-processing content on which the content adaptation service is effected, and transfers the post-processing content to said client device.

4. A content adaptation service control system according to claim 1, wherein the content adaptation service includes access filtering to said content server device on the basis of URL, an insertion of an advertisement suited to a favorite of the user, a virus check and a language translation.

5. A content adaptation service control system according to claim 1, wherein said service control device includes a first storage module retaining an identifier of said client device utilized by the user and content adaptation service category information as the contract information about the user subscribing the content adaptation service.

6. A content adaptation service control system according to claim 5, wherein said service control device further includes a second storage module retaining attribute information of a pre-processing content corresponding to the original content data, a mode of the content adaptation service applied to the pre-processing content, attribute information of a post-processing content on which the content adaptation service is effected, and an identifier of an edge device in which the post-processing content is stored as a cache.

7. A content adaptation service control system according to claim 6, wherein said service control device further includes a third storage module retaining an identifier of said client device that provided with the content adaptation service, content adaptation service category information, and service providing time information as accounting information about the content adaptation service.

8. A content adaptation service control system according to claim 1, wherein said edge device includes:
a content transfer module transmitting and receiving the content to and from at least one of said client device, said content server device, said content adaptation server device and other edge device;
an interworking module interworking with at least one of said service control device and said content adaptation server device;
a first cache module retaining as a cache the pre-processing content corresponding to the original content data;
a second cache module retaining as a cache the post-processing content corresponding to a result of the content adaptation service effected in said content adaptation server device on the basis of the original content data; and
a proxy module judging the necessity for starting the content adaptation service and cooperating with said first cache module, said second cache module and said interworking module.

9. A content adaptation service control system according to claim 8, wherein said edge device further includes:
a client module requesting said other edge device to acquire the post-processing content cached in said second cache module; and
a server module transmitting, as a response, the post-processing content cached in said second cache module in a self edge device in response to a request from a client module in said other edge device.

10. A content adaptation service control system according to claim 6, wherein said service control device:
determines a mode of the content adaptation service that should be applied to the pre-processing content requested by said client device;
thereafter searches said second storage module wherein the attribute information of the pre-processing content requested by said client device and the mode of the content adaptation service applied to the pre-processing content, are used as key information;
detects that a cache corresponding to the post-processing content concerned exists is retained in said edge device as a present control target;
commands in this case said edge device to use a cache corresponding to the post-processing content without carrying out the content adaptation service in said content adaptation server device, and transmits the post-processing content to said client device from said edge device.

11. A content adaptation service control system according to claim 6, wherein said service control device:
determines a mode of the content adaptation service that should be applied to the pre-processing content requested by said client device;
thereafter searches said second storage module wherein the attribute information of the pre-processing content requested by said client device and the mode of the content adaptation service applied to the pre-processing content, are used as key information;
detects that a cache corresponding to the post-processing content concerned exists is retained in other edge device that is not set as a present control target;
commands in this case said present control target edge device to acquire a cache corresponding to the post-processing content from said other edge device retaining the cache corresponding to the post-processing content without carrying out the content adaptation service in said content adaptation server device, and transfers the post-processing content acquired by said edge device to said client device.

12. A content adaptation service control system according to claim 6, wherein said service control device, when the post-processing content is generated in said content adaptation server device or when acquiring the post-processing content from said other edge device, selects as to whether the post-processing content is cached in said cache module of said present control target edge device, and, on the occasion of caching it, registers respective pieces of information about the post-processing content in said second storage module.

13. A content adaptation service control system according to claim 6, wherein said service control device, when detecting that the pre-processing content retained in said content server device has been updated, requests said edge device retaining as the cache the post-processing content generated based on the pre-processing content or said server module of in said other edge device to delete the post-processing content from said cache module, and deletes the respective pieces of information about the delete target post-processing content from said second storage module.

14. A content adaptation service control system according to claim 6, wherein said service control device, when detecting that the pre-processing content retained in said content server device is updated, makes said client module in said edge device or said other edge device generate an acquisition request of the updated pre-processing content, performs control of applying the content adaptation service to the pre-processing content, and
said client module of said edge device or said other edge device, when acquiring from said content adaptation server device the post-processing content to which the content adaptation service is applied, registers the post-processing content in said cache module.
